(19) United States
(12) Patent Application Publication
(10) Pub. No.: US 2026/0220215 A1
(43) Pub. Date: Jul. 30, 2026

(54) METHODS, COMPUTING DEVICES AND SYSTEMS FOR PERFORMING A METASEARCH OF DATA

(71) Applicant: Roman Vladimirovich Postnikov, Moscow (RU)

(72) Inventor: Roman Vladimirovich Postnikov, Moscow (RU)

(21) Appl. No.: 19/572,936

(22) Filed: Mar. 20, 2026

Related U.S. Application Data
(63) Continuation of application No. PCT/RU2024/050221, filed on Sep. 22, 2024.

(30) Foreign Application Priority Data
Sep. 22, 2023 (RU) 2023124500

(51) Int. Cl. G06F 16/9538; G06F 16/2457; H04L 9/40

(52) U.S. Cl. CPC G06F 16/9538; G06F 16/24578; H04L 63/10

(57) ABSTRACT

Variants of a method, a computing device, and a system for performing data metasearch are proposed, implementing the following functional features: (i) enabling user interaction for entry of a user search query, (ii) enabling creation of a secure connection with a server so as to transmit the received user search query over the secure connection with the server, (iii) enabling reception from the server of one or more network addresses of information resources corresponding to the user search query over the secure connection, (v) enabling transmission of at least one search query over a communication network, associated with a user computing device identifier, to at least one of the information resources using a respective address in the communication network, (vi) enabling reception of search results from information resources to which search queries were transmitted, and (vii) enabling ranking of the received search results at the computing device or the server.

### TECHNICAL FIELD

The present invention relates to the field of computing technology, in particular to computing devices, methods and systems used for implementing metasearch of data.

### BACKGROUND ART

Currently, various computing devices are known from the prior art that can be used for implementing metasearch of data.

In particular, in U.S. patent application No. 2021125997 (hereinafter US 2012066200), published on Mar. 15, 2012 (IPC: G06F 17/30), a method for implementing metasearch of data is disclosed, according to which: (i) an HTTP request is received for a metasearch engine from a client device to send a plurality of search queries to a plurality of separate hosts that provide access to the sought information, wherein the HTTP request from the client device is associated with a plurality of travel-related objects; (ii) said plurality of search queries are directed to separate hosts in response to the HTTP request received from the client device; (iii) search results are received from said plurality of separate hosts in response to said plurality of search queries directed to said plurality of separate hosts; (iv) said received search results are added to a response being formed; (v) said response from the metasearch engine is communicated to the client device; (vi) another HTTP request is received from the client device to place an order for at least one of said plurality of travel-related objects; and (vii) said placed order is processed.

It should be noted that in the method for implementing metasearch of data disclosed in US 2012066200, the search queries from the metasearch engine to separate hosts can be identified by said hosts as requests from a third-party aggregator service, bot, scraper or as requests in a DDoS attack, rather than as real requests from a user, especially in the event that said hosts receive mass search queries from the same metasearch engine (for example, in the event the metasearch engine receives HTTP requests from multiple client devices), which can ultimately lead to blocking of such metasearch engine at said hosts.

It should also be noted that in the method for implementing metasearch of data disclosed in US 2012066200, search queries to separate hosts are associated with the client HTTP request from the client device, however such search queries can be automatically identified by hosts as originating from the metasearch engine rather than from the client device, in particular based on the identification data of the metasearch engine (for example, the IP address of the server containing the metasearch engine) contained in said search queries, which can ultimately lead to a significant reduction in the relevance of the search results that will be provided in response to the client device in US 2012066200 with respect to the user (in particular, search results may be provided taking into account the geographical location of the server with the metasearch engine rather than the client device, in the event the IP address of the source of the request contained in the search query is used in ranking the search results).

Thus, the main disadvantage of known methods for implementing metasearch of data, including the method for implementing metasearch of data disclosed in US 2012066200, is that they can lead to blocking of the source of search queries and/or may provide insufficiently relevant search results to the user.

Thus, it is obvious that there is a need for further improvement of known methods for implementing metasearch of data, in particular to eliminate or minimize the probability of blocking the source of search queries and/or to increase the relevance of search results to the user.

Consequently, the technical problem solved by the present invention is to provide a method, a computing device and a system for implementing metasearch of data, in each of which at least one of the designated disadvantages of the known method for implementing metasearch of data is at least partially eliminated, which disadvantages consist in the possibility of blocking the source of search queries and low relevance of search results.

An additional technical problem solved by the present invention consists in expanding the arsenal of technical means capable of implementing metasearch of data.

### DISCLOSURE OF THE INVENTION

The object of the present invention is to provide a method, a computing device and a system for implementing metasearch of data, in each of which at least the designated technical problem above is solved.

Another object of the present invention is to provide an alternative method, computing device, and system for implementing metasearch of data with respect to technical solutions known in the prior art.

Each of the posed objects is solved in the first aspect of the present invention due to the fact that the proposed method for implementing metasearch of data, performed on a user computing device with one or more processors, contains steps according to which: (i) provision is made for user interaction to allow a user to input a user search query; (ii) a network connection is created with a server to ensure transmission of said input user search query over said network connection with the server; (iii) one or more network addresses of information resources are received from the server over said network connection in response to said user search query; (iv) at least one search query is transmitted over the communication network, correlated with an identifier of the user computing device, to at least one of said information resources using a respective address in the communication network; (v) search results are received from the information resources to which search queries were transmitted, ensuring their redirect to the server over said network connection; (vi) ranked search results are received from the server over said network connection.

Each of the posed objects is solved in the second aspect of the present invention due to the fact that the proposed method for implementing metasearch of data, performed on a user computing device with one or more processors, contains steps according to which: (i) provision is made for user interaction to allow a user to input a user search query; (ii) a network connection is created with a server to ensure transmission of said input user search query over said network connection with the server; (iii) one or more network addresses of information resources are received from the server over said network connection in response to said input user search query; (iv) at least one search query is transmitted over the communication network, correlated with an identifier of the user computing device, to at least one of said information resources using a respective address in the communication network; (v) search results are received from the information resources to which search queries were transmitted; and (vi) said received search results are ranked to obtain ranked search results, wherein according to said method additionally (vii) provision is made for user interaction to allow transmission by the user of authorization data for one or more information resources, (viii) said authorization data are transmitted to said server over said network connection, (ix) one or more server authorization requests are received from the server, each corresponding to the user search query and corresponding to one of said information resources for which authorization data were transmitted to said server, over said network connection with provision for issuing a user authorization request to each of the information resources corresponding to said server authorization requests over the communication network, and (x) authorization keys are received from said information resources to which user authorization requests were issued over the communication network with provision for issuing them to said server over said network connection, wherein the network addresses of information resources in the communication network received from the server additionally correspond to said authorization keys, and each search query, transmitted by the user computing device over the communication network to an information resource in accordance with one of said information resource addresses, additionally contains an authorization key corresponding to said information resource.

Furthermore, each of the posed objects is solved in the third aspect of the present invention due to the fact that the proposed computing device for implementing metasearch of data contains: (i) a user interaction module configured to enable a user to input a user search query; and (ii) a computing module connected in data exchange capability with the user interaction module to receive said user search query and configured to enable performance of at least the following operations according to which: (a) provision is made for creating a network connection with a server to transmit said input user search query over said network connection with the server; (b) provision is made for receiving from the server one or more network addresses of information resources over said network connection in response to said user search query; (c) provision is made for transmitting at least one search query over the communication network, correlated with an identifier of the user computing device, to at least one of said information resources using a respective address in the communication network; (d) provision is made for receiving search results from the information resources to which search queries were transmitted, ensuring the possibility of their redirect to the server over said network connection, and (e) provision is made for receiving ranked search results from the server over said network connection.

Furthermore, each of the posed objects is solved in the fourth aspect of the present invention due to the fact that the proposed computing device for implementing metasearch of data contains: (i) a user interaction module configured to enable a user to input a user search query; and (ii) a computing module connected in data exchange capability with the user interaction module to receive said user search query and configured to enable performance of at least the following operations according to which: (a) provision is made for creating a network connection with a server to transmit said input user search query over said network connection with the server; (b) provision is made for receiving from the server one or more network addresses of information resources over said network connection in response to said user search query; (c) provision is made for transmitting at least one search query over the communication network, correlated with an identifier of the user computing device, to at least one of said information resources using a respective address in the communication network; (d) provision is made for receiving search results from the information resources to which search queries were transmitted; and (e) rank said received search results to obtain ranked search results, wherein the user interaction module is additionally configured to enable transmission by the user of authorization data for one or more information resources, and the computing module is additionally configured to enable performance of at least the following operations according to which: (f) transmit said authorization data to said server over said network connection, (g) receive from the server one or more server authorization requests, each corresponding to the user search query and corresponding to one of said information resources for which authorization data were transmitted to said server, over said network connection with provision for issuing a user authorization request to each of the information resources corresponding to said server authorization requests over the communication network, and (h) receive authorization keys from said information resources to which user authorization requests were issued over the communication network with provision for issuing them to said server over said network connection, wherein the network addresses of information resources in the communication network received from the server additionally correspond to said authorization keys, and each search query, transmitted by the user computing device over the communication network to an information resource in accordance with one of said information resource addresses, additionally contains an authorization key corresponding to said information resource.

Furthermore, each of the posed objects is solved in the fifth aspect of the present invention due to the fact that the proposed method for implementing metasearch of data contains steps according to which: (i) provision is made through a user computing device for enabling a user to input a user search query; (ii) a network connection is created through a user computing device with a server to ensure transmission of said user search query over said network connection with the server; (iii) one or more network addresses of information resources are provided through said server over said network connection from said server to said user computing device in response to said input user search query; (iv) at least one search query is transmitted through the user computing device over the communication network, correlated with an identifier of the user computing device, to at least one of said information resources using a respective address in the communication network received from said server; (v) search results are received through the user computing device from the information resources to which search queries were transmitted, ensuring their redirect to said server over said network connection; and (vi) said search results are ranked through said server to obtain ranked search results with provision for their delivery to the user computing device over said network connection.

Furthermore, each of the posed objects is solved in the sixth aspect of the present invention due to the fact that the proposed method for implementing metasearch of data contains steps according to which: (i) provision is made through a user computing device for enabling a user to input a user search query; (ii) a network connection is created through a user computing device with a server to ensure transmission of said user search query over said network connection with the server; (iii) one or more network addresses of information resources are provided through said server over said network connection from said server to said user computing device in response to said user search query; (iv) at least one search query is transmitted through the user computing device over the communication network, correlated with an identifier of the user computing device, to at least one of said information resources using a respective address in the communication network received from said server; (v) search results are received through the user computing device from the information resources to which search queries were transmitted; and (vi) said search results are ranked through the user computing device to obtain ranked search results, wherein according to said method additionally (vii) provision is made through the user computing device for enabling transmission by the user of authorization data for one or more information resources, (viii) said authorization data are transmitted through the user computing device to said server over said network connection, (ix) said authorization data are processed through said server to create one or more server authorization requests, each corresponding to the user search query and corresponding to one of said information resources for which authorization data were transmitted to said server, with provision for delivery of said server authorization requests to the user computing device over said network connection, (x) a user authorization request is provided through the user computing device to each of the information resources corresponding to said server authorization requests over the communication network, and (xi) authorization keys are received from said information resources to which user authorization requests were issued over the communication network with provision for delivery to said server over said network connection, wherein the network addresses of information resources in the communication network received from the server additionally correspond to said authorization keys, and each search query, transmitted by the user computing device over the communication network to an information resource in accordance with one of said information resource addresses, additionally contains an authorization key corresponding to said information resource.

Furthermore, each of the posed objects is solved in the seventh aspect of the present invention due to the fact that the proposed system for implementing metasearch of data contains: (i) a server for implementing metasearch of data; and (ii) a user computing device for implementing metasearch of data connected in data exchange capability with said server over the communication network and containing at least one processor configured to enable performance of at least the following operations according to which: (i) provision is made for user interaction to allow a user to input a user search query, and (ii) a network connection is created with said server through said communication network with provision for the possibility of transmission of said user search query over said network connection with the server, wherein said server is additionally configured to deliver one or more network addresses of information resources over said network connection to the user computing device in response to said input user search query, the user computing device is additionally configured to transmit at least one search query over the communication network, correlated with an identifier of the user computing device, to at least one of said information resources using a respective address in the communication network received from said server, and to receive search results from the information resources to which search queries were transmitted, with provision for the possibility of their redirect to said server over said network connection, and said server is additionally configured to rank said search results received from the user computing device to obtain ranked search results with provision for the possibility of their delivery to the user computing device over said network connection.

Furthermore, each of the posed objects is solved in the eighth aspect of the present invention due to the fact that the proposed system for implementing metasearch of data contains: (i) a server for implementing metasearch of data; and (ii) a user computing device for implementing metasearch of data connected in data exchange capability with said server over the communication network and containing at least one processor configured to enable performance of at least the following operations according to which: (i) provision is made for user interaction to allow a user to input a user search query, and (ii) a network connection is created with said server through said communication network with provision for the possibility of transmission of said user search query over said network connection with the server, wherein said server is additionally configured to deliver one or more network addresses of information resources over said network connection to the user computing device in response to said user search query, and the user computing device is additionally configured to enable performance of at least the following operations according to which: (a) at least one search query is transmitted over the communication network, correlated with an identifier of the user computing device, to at least one of said information resources using a respective address in the communication network received from said server; (b) search results are received from the information resources to which search queries were transmitted; and (c) rank said received search results to obtain ranked search results, wherein the user computing device is additionally configured to enable transmission by the user of authorization data for one or more information resources and is configured to transmit said authorization data to said server over said network connection, and said server is additionally configured to process said authorization data to create one or more server authorization requests, each corresponding to the user search query and corresponding to one of said information resources for which authorization data were transmitted to said server, with provision for the possibility of delivering said server authorization requests to the user computing device over said network connection, wherein the user computing device is also configured to enable performance of the following operations according to which: (d) provide a user authorization request to each of the information resources corresponding to said server authorization requests over the communication network, and (e) receive authorization keys from said information resources to which user authorization requests were issued over the communication network with provision for delivering them to said server over said network connection, wherein the network addresses of information resources in the communication network received from the server additionally correspond to said authorization keys, and each search query, transmitted by the user computing device over the communication network to an information resource in accordance with one of said information resource addresses, additionally contains an authorization key corresponding to said information resource.

The method for implementing metasearch of data according to the first aspect of the present invention, the method for implementing metasearch of data according to the second aspect of the present invention, the computing device for implementing metasearch of data according to the third aspect of the present invention, the computing device for implementing metasearch of data according to the fourth aspect of the present invention, the method for implementing metasearch of data according to the fifth aspect of the present invention, the method for implementing metasearch of data according to the sixth aspect of the present invention, the system for implementing metasearch of data according to the seventh aspect of the present invention, and the system for implementing metasearch of data according to the eighth aspect of the present invention each provide a technical effect consisting in increasing the accuracy of search results. In particular, increased accuracy of search results is achieved due to the issuance of search queries to information resources directly from the user computing device with the participation of a server that delivers network addresses of these information resources to the user computing device as a result of processing the user search query corresponding to said user computing device.

Furthermore, the method for implementing metasearch of data according to the first aspect of the present invention, the method for implementing metasearch of data according to the second aspect of the present invention, the computing device for implementing metasearch of data according to the third aspect of the present invention, the computing device for implementing metasearch of data according to the fourth aspect of the present invention, the method for implementing metasearch of data according to the fifth aspect of the present invention, the method for implementing metasearch of data according to the sixth aspect of the present invention, the system for implementing metasearch of data according to the seventh aspect of the present invention, and the system for implementing metasearch of data according to the eighth aspect of the present invention each provide an additional technical effect consisting in increasing the efficiency of the metasearch data implementation process.

Furthermore, the method for implementing metasearch of data according to the first aspect of the present invention, the method for implementing metasearch of data according to the second aspect of the present invention, the computing device for implementing metasearch of data according to the third aspect of the present invention, the computing device for implementing metasearch of data according to the fourth aspect of the present invention, the method for implementing metasearch of data according to the fifth aspect of the present invention, the method for implementing metasearch of data according to the sixth aspect of the present invention, the system for implementing metasearch of data according to the seventh aspect of the present invention, and the system for implementing metasearch of data according to the eighth aspect of the present invention each provide yet another additional technical effect consisting in reducing the volume of computing resources and memory resources allocated by the computing device used for direct user interaction for implementing metasearch of data. In particular, the reduction in computing resources and memory resources allocated by the user computing device for implementing the metasearch data process is due to the performance of part of the operations related to metasearch data implementation on the server.

Furthermore, the method for implementing metasearch of data according to the first aspect of the present invention, the method for implementing metasearch of data according to the second aspect of the present invention, the computing device for implementing metasearch of data according to the third aspect of the present invention, the computing device for implementing metasearch of data according to the fourth aspect of the present invention, the method for implementing metasearch of data according to the fifth aspect of the present invention, the method for implementing metasearch of data according to the sixth aspect of the present invention, the system for implementing metasearch of data according to the seventh aspect of the present invention, and the system for implementing metasearch of data according to the eighth aspect of the present invention each provide yet another additional technical effect consisting in increasing the level of data protection received by the computing device used for direct user interaction and involved in implementing metasearch of data. In particular, the increased level of data protection is due to the fact that the user computing device receives data used to implement the metasearch data process from the server over a network connection that the user computing device establishes with the server.

Furthermore, the method for implementing metasearch of data according to the first aspect of the present invention, the method for implementing metasearch of data according to the second aspect of the present invention, the computing device for implementing metasearch of data according to the third aspect of the present invention, the computing device for implementing metasearch of data according to the fourth aspect of the present invention, the method for implementing metasearch of data according to the fifth aspect of the present invention, the method for implementing metasearch of data according to the sixth aspect of the present invention, the system for implementing metasearch of data according to the seventh aspect of the present invention, and the system for implementing metasearch of data according to the eighth aspect of the present invention each provide yet another additional technical effect consisting in expanding the arsenal of technical means capable of implementing metasearch of data, in particular in the creation of more universal technical means capable of implementing metasearch of data in various data sources or on various information resources.

It should be noted that depending on the specific embodiment of the present invention and the technical solution disclosed in one of the information sources constituting the prior art for the present invention, the present invention can provide at least one of the following additional technical effects: optimization of the metasearch data implementation process, increasing the efficiency of the metasearch data implementation process, increasing the level of data security during data exchange, reducing the risk of data loss when implementing metasearch of data, accelerating the receipt of search results when implementing metasearch of data, reducing the risk of blocking the search source when implementing metasearch of data, increasing user anonymity when implementing metasearch of data, and the like.

### BRIEF DESCRIPTION OF THE DRAWINGS

The attached drawings, which are provided to give a better understanding of the substance of the present invention, form a part of this document and are included in it to illustrate the embodiments and aspects of the present invention described below. The attached drawings in conjunction with the description provided below serve to explain the substance of the present invention. In the drawings:

FIG. 1 shows a block diagram illustrating one exemplary embodiment of a system for implementing metasearch of data according to the present invention, which includes a computing device for implementing metasearch of data and a server for implementing metasearch of data;

FIG. 2 shows a flowchart illustrating the main operations of a method for implementing metasearch of data according to the present invention, which is implemented by the user computing device shown in FIG. 1 as part of the system for implementing metasearch of data; and

FIG. 3 shows a flowchart illustrating the main operations of a method for implementing metasearch of data according to the present invention, which is implemented by the system for implementing metasearch of data shown in FIG. 1.

### DETAILED DESCRIPTION OF EMBODIMENTS

Some examples of possible embodiments of the present invention are described below, and it should not be considered that the description provided below defines or limits the scope of the present invention.

All specific examples provided in this document, or at least some of them, as well as the corresponding phrases (“for example”, “such as”, “in particular” or the like), are essentially used to improve understanding of the substance of the present invention and to ensure completeness of disclosure of the present invention, however, these phrases do not impose any limitations on the embodiments of the present invention for which they are used in this document, in particular do not limit the practical embodiments of functional components, modules, blocks, devices, means and/or the like used to disclose the features of the structure and operation of the present invention.

### System for Implementing Meta-Search of Data

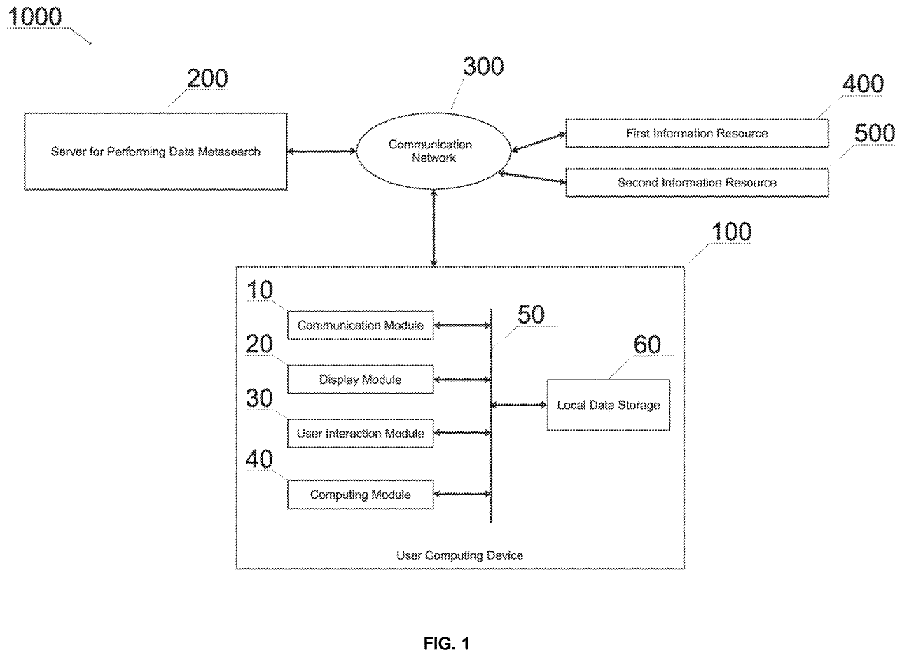

FIG. 1 shows one illustrative embodiment of a system 1000 for implementing metasearch of data according to the present invention, which includes a user computing device 100 for implementing metasearch of data according to the present invention, configured to establish communication over a communication network 300 with a first information resource 400 and/or a second information resource 500 with provision for the possibility of data exchange, and a server 200 for implementing metasearch of data according to the present invention, connected for data exchange capability over the communication network 300 with the computing device 100.

The user computing device 100 must be pre-programmed or configured to identify data streams from the server 200 based on one or more unique identifiers of the server contained in these data streams and previously known to the computing device 100. In turn, the server 200 must also be pre-programmed or configured to identify data streams from the user computing device 100 based on one or more unique identifiers of the user computing device contained in these data streams and previously known to the server 200. It should be noted that unique identifiers of the user computing device may be communicated to the server 200 over the communication network 300 when the user installs special software for use in the system 1000 and starts it on the user computing device 100 to register the user in the system 1000 using said installed software. Similarly, unique identifiers of the user computing device may be communicated to the server 200 when the user installs special software for use in the system 1000 and establishes a communication session over the communication network 300 with the server 200 upon initial startup by the user of said installed software on the user computing device 100. It should also be noted that any data streams transmitted by the user computing device 100 over the communication network 300 are automatically (by default) correlated with one or more unique identifiers of the user computing device, and any data streams transmitted by the server 200 over the communication network 300 are automatically (by default) correlated with one or more unique identifiers of the server.

The first information resource 400 and the second information resource 500 shown in FIG. 1 are provided solely as an example for describing the operation of the system 1000, and it should be obvious to a person skilled in the art that the user computing device 100 can be configured to establish communication over the communication network 300 with a plurality of similar information resources (for example, dozens, hundreds, thousands, tens of thousands, hundreds of thousands, millions or the like), wherein at least one or each of such information resources may represent a search service, a search engine, an aggregator site, an electronic data catalog, a database, an electronic archive, a goods/services website with a data search function on the website or any other information network resource for data search having its own network address, to which access can be obtained over the communication network to search for data in it in accordance with keywords from a search query.

The communication network 300 shown in FIG. 1 may represent the Internet, a cellular network, an Ethernet network, an LTE network, a Wi-Fi network, a 3G network, a 4G network, a 5G network or any other suitable wireless communication network known in the prior art.

It should be noted that the server 200 is shown in FIG. 1 solely as an example, that is, it should not be considered that a possible implementation of the system 1000 for implementing metasearch of data is limited to only one server 200. It should be obvious to a person skilled in the art that the system 1000 for implementing metasearch of data may contain two or more servers, each similar to the server 200 and each configured to exchange data over the communication network 300 with the user computing device 100 and with each other when implementing metasearch of data, wherein the functional operations (capabilities) described in this document with respect to the server 200 can be distributed in any suitable manner among said two or more servers.

It should also be noted that the user computing device 100 is shown in FIG. 1 solely as an example, that is, it should not be considered that a possible implementation of the system 1000 for implementing metasearch of data is limited to only one user computing device 100. It should be obvious to a person skilled in the art that the system 1000 for implementing metasearch of data may contain two or more user computing devices (for example, five, ten, fifty, one hundred, five hundred, one thousand, five thousand, ten thousand, fifty thousand, one hundred thousand and the like), each similar to the user computing device 100 and each configured to exchange data over the communication network 300 with the server 200 when implementing metasearch of data, wherein the functional operations (capabilities) described in this document with respect to the user computing device 100 will essentially be present in full for any of said two or more user computing devices.

### User Computing Device for Implementing Meta-Search of Data

As shown in FIG. 1, the user computing device 100 for implementing metasearch of data contains a communication module 10, a display module 20, a user interaction module 30, a computing module 40 and a local data storage 60, which are configured to exchange data with each other through a communication bus 50 to which they are all connected, wherein the communication module 10, the display module 20, the user interaction module 30, the computing module 40, the local data storage 60 and the communication bus 50 are housed in a single enclosure.

The user computing device 100 shown in FIG. 1 represents a hardware-software complex, which can preferably be implemented, for example, as an ordinary smartphone with an operating system “Android” (any versions and modifications), “iPhone OS” (any versions and modifications), “Hongmeng” (any versions and modifications), “HarmonyOS” (any versions and modifications) or “Aurora OS” (any versions and modifications), the structure and capabilities of which are well known to specialists in this field of technology.

Furthermore, the user computing device 100 can be implemented as a general-purpose computer having the structure described below or a similar structure well known to specialists in this field of technology.

In particular, a general-purpose computer in the form of which the user computing device 100 described in this document can be implemented typically contains a central processor, system memory and a system bus, which in turn contains various system components, including memory associated with the central processor. The system bus in such a general-purpose computer contains a memory bus and memory bus controller, a peripheral bus and a local bus configured to interact with any other bus architecture. The system memory contains a read-only memory (ROM) and random access memory (RAM). The basic input/output system (BIOS) contains basic procedures that ensure the transfer of information between elements of such a general-purpose computer, for example, at the moment of loading the operating system using ROM. Furthermore, a general-purpose computer contains a hard disk for reading and writing data, a magnetic disk drive for reading and writing to removable magnetic disks and an optical drive for reading and writing to removable optical disks, such as CD-ROMs, DVD-ROMs and other optical storage media, however, computer storage media of other types that are configured to store data in machine-readable form, such as solid-state drives, flash cards, digital disks, etc., may be used and connected to the system bus through a controller. In a general-purpose computer, the hard disk, magnetic disk drive and optical drive are connected to the system bus through a hard disk interface, magnetic disk interface and optical drive interface respectively. Drives and corresponding computer storage media represent non-volatile means of storing computer instructions, data structures, software modules and other data of the general-purpose computer. A general-purpose computer has a file system in which the recorded operating system and additional software applications, other software modules and program data are stored. A user has the ability to input commands and information to a general-purpose computer using known input devices, such as a keyboard, a mouse-type manipulator, a microphone, a joystick, a game console, a scanner, and the like, wherein these input devices typically gain access to the general-purpose computer through a serial port, which in turn is connected to the system bus, however, they can be connected in other ways, for example, using a parallel port, game port or universal serial bus (USB). A monitor or other type of display device is also connected to the system bus through an interface, such as a video adapter. In addition to the monitor, a personal computer may be equipped with other peripheral output devices, such as speakers, a printer, and the like. A general-purpose computer is able to operate in a network environment, wherein a network connection can be used to connect to one or more remote computers. Network connections may form a local area network (LAN) and a wide area network (WAN). Such networks are typically used in corporate computer networks and company internal networks, and they have access to the Internet. In LAN or WAN networks, a general-purpose computer is connected to a local network through a network adapter or network interface. When using networks, a general-purpose computer may use a modem, network card, adapter or other means of ensuring communication with a wide area network, such as the Internet, wherein these means of communication are connected to the system bus through a serial port. It should be noted that in the ROM of the general-purpose computer or at least on any one of the above-described machine-readable storage media that can be used in the general-purpose computer, machine-readable instructions may be stored, to which the central processor of this general-purpose computer may have access, wherein the execution of these machine-readable instructions on the general-purpose computer may cause the execution by its central processor of various procedures or operations described below in this document.

In some embodiments of the present invention, the user computing device 100 may represent, among other things, a mobile telephone, a cellular telephone, a tablet, a laptop, a netbook, an e-book, an all-in-one computer, a desktop computer, smart glasses, smart watches, a smart television, a smart speaker, a server or similar known electronic computing device configured to establish wireless communication with the server 200 to transmit to it at least one user search query, on the basis of which the server 200 implements its functional operations related to implementing the metasearch data process and described below in this document, and delivers response data to said computing device, used in the operation of the computing device 100 to implement its functional operations related to implementing the metasearch data process and described below in this document. Thus, the implementation of the user computing device 100 in the present invention is not limited to any specific electronic computing device known in the prior art for solving the tasks posed, and any known electronic computing device suitable for solving the tasks posed and described in this document with respect to the computing device 100 can be used as the user computing device 100 in the present invention.

In other embodiments of the present invention, the user computing device 100 for implementing metasearch of data may be implemented as a combination of hardware, software and/or hardware-software complex suitable for solving the tasks described in this document with respect to the computing device 100.

### Local Data Storage

The local data storage 60 shown in FIG. 1 as part of the user computing device 100 is intended for storing executable instructions that can control the operation of at least the communication module 10, the display module 20, the user interaction module 30 and the computing module 40, and is intended for storing various system data used in the operation of the user computing device 100 as part of the system 1000 and in the implementation by the user computing device 100 of its functional capabilities described in this document, and at least one of the following working data: (i) user request data, (ii) data about network addresses of information resources received from the server 200, (iii) data about search queries transmitted to information resources, (iv) data about search results received from information resources, (v) data about ranked search results, (vi) authorization data for user authorization on information resources, (vii) data about authorization keys received from information resources in response to authorization requests, (viii) data about intermediate results of the implementation by the user computing device 100 of a functional operation described in this document with respect to the user computing device 100, and/or any other data of long-term or temporary storage necessary to ensure proper operation of the user computing device 100 as part of the system 1000.

It should be noted that any data stored in the local data storage 60 are correlated with at least a unique identifier of the data source or unique identifier of the data receiver and a unique identifier of the user computing device, wherein as said receiver or said source may be, for example, the server 200 or any of the first and second information resources 400, 500.

The local data storage 60 can also at least temporarily store at least one of the following interface data: (i) interface data for displaying keywords of the user search query, (ii) interface data for displaying ranked search results, (iii) interface data for displaying instructions or hints to the user for entering data, (iv) interface data for displaying instructions or hints regarding available means for indicating or transmitting by the user of the user search query or user authorization data, and (v) other interface data necessary for implementing metasearch of data using the computing device 100.

Furthermore, the local data storage 60 can store auxiliary data, such as, for example, algorithm data for recognizing or identifying input data streams, algorithm data for establishing a secure state within the communication network 300, algorithm data for initiating hidden web browser processes on the user computing device 100 for implementing user authorization over the communication network 300, and the like.

In some embodiments of the present invention, the local data storage 60 in the user computing device 100 may contain one or more databases, each configured to store in them at least one separate group or set of data from the aforementioned groups or sets of data used in the operation of the user computing device 100 as part of the system 1000 and in the implementation by the user computing device 100 of its functional capabilities described in this document.

In other embodiments of the present invention, the user computing device 100 may use at least one separate remote data storage (not shown) to store in it at least a part of the aforementioned groups of data or all of these groups of data used in the operation of the user computing device 100 as part of the system 1000 (for example, interface data), wherein the display module 20, the user interaction module 30 and/or the computing module 40 can access said separate remote data storage using the communication module 10 connected in the user computing device 100 to the communication bus 50 and configured to connect to separate remote data storages in a wired manner and/or wirelessly.

In some other embodiments of the present invention, the user computing device 100 may contain one or more local data storages (not shown) and may have or gain access to one or more remote data storages (not shown), wherein each of such data storages may be intended for storing at least one group of data from the aforementioned groups of data used in the operation of the user computing device 100 as part of the system 1000 and in the implementation by the user computing device 100 of its functional capabilities described in this document. In such embodiments of the present invention, the local data storages may each be connected to the communication module 10, the display module 20, the user interaction module 30 and/or the computing module 40 using the communication bus 50, and the remote data storages may each be connected in a wired manner and/or wirelessly to the display module 20, the user interaction module 30 and/or the computing module 40 using the communication module 10 connected in the user computing device 100 to the communication bus 50. Thus, for example, an embodiment of the present invention is possible in which the user computing device 100 contains a single local data storage 60 storing, for example, exclusively user search queries, and several remote data storages storing other groups of data used in the operation of the user computing device 100 as part of the system 1000 and in the implementation by the user computing device 100 of its functional capabilities described in this document.

In one embodiment of the present invention, at least one of the aforementioned groups of data used in the operation of the user computing device 100 as part of the system 1000 and in the implementation by the user computing device 100 of its functional capabilities described in this document may be stored in a corresponding separate local data storage (not shown) different from the local data storage 60 and connected by the communication bus 50 to the communication module 10, the display module 20, the user interaction module 30 and/or the computing module 40, which in turn may each be additionally configured to connect via the communication bus 50 to any such separate local data storages with provision for the possibility of retrieving necessary data from them and/or the possibility of writing necessary data to them.

The local data storage 60 can be implemented, for example, as one or more physical machine-readable storage media for long-term data storage known in the prior art. In some embodiments of the present invention, the local data storage 60 can be implemented using a single physical device (for example, an SSD, flash memory, etc.), and in other embodiments, the local data storage 60 can be implemented using two or more storage devices known in the prior art.

### Communication Module

The communication module 10 shown in FIG. 1 as part of the user computing device 100 has wireless communication over the communication network 300 with the server 200 with the possibility of exchanging data with it when establishing a communication channel between them.

It should be noted that the communication module 10 as part of the user computing device 100 is connected via the communication bus 50 with the capability of data exchange to the computing module 40 described below, the display module 20 described below, and the user interaction module 30 described below, wherein the computing module 40 can essentially manage the operation of the communication module 10.

The communication module 10 can be used to transmit to the server 200 or deliver to the server 200 data packets or data streams of the computing device having a specified format description known to the server 200, or to receive from the server 200 data packets or data streams of the server having a specified format description known to the computing device 100. Furthermore, the communication module 10 can be used to direct various requests (including system requests) and/or commands of the computing device 100 to the server 200, as well as to receive various requests, commands, system responses/confirmations and/or requested data from the server 200.

Furthermore, the communication module 10 can be used to establish communication over the communication network 300 with the information resources 400, 500, each of which has a pre-set network address in the communication network 300, with provision for the possibility of delivering to each of said information resources 400, 500 data packets or data streams of the computing device having a specified format description automatically identified by said information resource, and the possibility of receiving from each of said information resources 400, 500 data packets or data streams of the server having a specified format description known to the computing device 100.

In particular, in the present invention, the communication module 10 essentially allows the computing device 100 to implement at least the following functional operations: (i) receive from the server 200 network addresses of information resources contained in the data stream transmitted from the server 200 to the computing device 100 using the communication network 300; and (ii) transmit the user search query to the server 200. In one embodiment of the present invention, the communication module 10 can also allow the computing device 100 to additionally receive ranked search results from the server 200. In another embodiment of the present invention, the communication module 10 can also allow the computing device 100 to additionally transmit authorization keys for information resources to the server 200. In another embodiment of the present invention, the communication module 10 can also allow the computing device 100 to additionally receive server authorization requests from the server 200.

In the present invention, the communication module 10 also allows the computing device 100 to implement at least the following additional functional operations: (i) transmit search queries to the information resources 400, 500 using their network addresses (i.e., addresses in the communication network 300); and (ii) receive search results from the information resources to which search queries were transmitted. In another embodiment of the present invention, the communication module 10 can also allow the computing device 100 to additionally provide user authorization requests to the information resources 400, 500. In another embodiment of the present invention, the communication module 10 can also allow the computing device 100 to additionally receive corresponding authorization keys from the information resources 400, 500. In other embodiments of the present invention, the communication module 10 can also allow the computing device 100 to transmit search queries to the information resources 400, 500 and receive search results from the information resources 400, 500 through a hidden web browser process created by the computing device 100, which essentially allows receiving search results from the information resources 400, 500 anonymously. In other embodiments of the present invention, the communication module 10 can also allow the computing device 100 to transmit authorization requests to the information resources 400, 500 and receive authorization keys from the information resources 400, 500 through a hidden web browser process created by the computing device 100, which essentially does not interfere with further operation of the user with the user computing device 100.

It should be noted that to establish a connection of the communication module 10 with the server over the communication network 300 and/or to establish a connection of the communication module 10 with the information resources 400, 500 over the communication network 300, the communication module 10 can be implemented as a network adapter in the form of a Wi-Fi adapter, 3G/4G/5G adapter, LTE adapter or other wireless adapter depending on the type of wireless communication line used to provide communication between the user computing device 100 and the server 200, that is, depending on the type of communication network 300.

The communication module 10 in the user computing device 100 can also represent a known communication device, such as a transmitter, receiver, transceiver, modem and/or network interface card for exchanging data with external devices of any type through a wired or wireless communication network, for example, using a network connection of the “Ethernet” standard, digital subscriber line communication (DSL), telephone line, coaxial cable, cellular communication system, and the like.

In the aforementioned embodiments of the present invention in which all groups of data used in the operation of the user computing device 100 as part of the system 1000 and in the implementation by the user computing device 100 of its functional capabilities described in this document, in particular in the operation of each of the functional modules included in the user computing device 100, or at least part of them are stored in at least one separate remote data storage, the communication module 10 can be configured to connect to said at least one remote data storage to obtain necessary data from it used in the operation of the user computing device 100 as part of the system 1000 and in the implementation by the user computing device 100 of its functional capabilities described in this document, for example the aforementioned interface data.

In some embodiments of the present invention, the communication module 10 in the user computing device 100 may be additionally configured to establish communication with at least one remote data source storing at least some data from groups of data used in the operation of the user computing device 100 as part of the system 1000 and in the implementation by the user computing device 100 of its functional capabilities described in this document, in particular in the operation of each of the functional modules included in the user computing device 100, or with the capability of connecting to such a data source with provision for the possibility of receiving from it data necessary for implementing the purpose of the user computing device 100 for implementing metasearch of data or implementing the functional purpose of the corresponding one of said functional modules of the user computing device 100. As such a remote data source, a remote computing device, cloud data storage, server, host, domain, database, program, website or the like can be used.

In other embodiments of the present invention, the communication module 10 may contain two or more different adapters, each of which can be configured to establish a connection with a data source with provision for the possibility of mutual data exchange and can be selected from the group of adapters containing: Wi-Fi adapter, 3G/4G/5G adapter, LTE adapter, Bluetooth adapter, IR adapter (irDA adapter) and the like, which allows the communication module to deliver data to different sources in real time or near real time and/or receive data from different data sources.

In other embodiments of the present invention, the communication module 10 can be connected wirelessly or in a wired manner with the capability of data exchange to at least one of the following external functional devices, each configured with the capability of user interaction to enable receipt from the user of a user search query: smart glasses, smart watches, a smart television, a smart speaker, a video camera (for example, an IP camera) or any other similar smart device known in the prior art. It should be noted that in such embodiments of the present invention, a coaxial cable, fiber optic cable or any other suitable physical connection known in the prior art can be used to implement a wired connection between the communication module 10 and one or more external functional devices for user interaction (not shown). In one variation of this embodiment of the present invention, one or more external functional devices for user interaction (not shown) connected to the communication module 10 in a wired or wireless manner may be included in the system 1000.

### Display Module

The display module 20 shown in FIG. 1 as part of the user computing device 100 is connected via the communication bus 50 to the computing module 40 described below with the capability of data exchange and to the communication module 10 with the capability of data exchange, wherein the computing module 40 is essentially configured to manage the operation of the display module 20 using a graphics processor or video card (not shown).

The display module 20 can be implemented, for example, as a display known in the prior art, such as an OLED display, IPS display, TFT display, LCD display, AMOLED display, P-OLED display, QLED display or the like. In one embodiment of the present invention, the display module 20 can support touch screen technology or MultiTouch technology, that is, it can represent a touch display module or touch display.

In the present invention, the display module 20 can receive via the communication bus 50 the user search query from the user interaction module 30 and at least some of the aforementioned interface data with provision for the possibility of displaying to the user said user search query in real time, so that the user can see in a designated area on the display module 20 the keywords of the user search query received by the user computing device 100 from the user. In one embodiment of the present invention, the display module 20 can receive via the communication bus 50 from the communication module 10 ranked search results delivered by the server 200 to the user computing device 100 with provision for the possibility of their display.

In some embodiments of the present invention, the display module 20 may not be part of the user computing device 100.

It should be noted that displaying the user search query on the display module 20 allows the user to understand whether the keywords of the user search query received by the user computing device 100 from the user correspond to what the user wanted to find and consequently whether it is necessary to correct or change the user search query to meet the user's needs for finding the necessary information.

In one embodiment of the present invention, the computing module 40 can provide the capability to deliver to the display module 20 data from the local data storage 60 (depending on the embodiment, as described above in this document from a separate local data storage using the communication bus 50 and/or remote data storage using the communication module 10 connected to the communication bus 50), in particular interface data that can be automatically requested by the computing module 40 when the user turns on (starts) or operates the computing device 100 with provision for their at least partial output to the display module 20 (i.e., at least partial display on the display module 20) via the communication bus 50, or which may be requested by the computing module 40 depending on the user's choice made through standard input/output means of the computing device 100.

In one embodiment of the present invention, the display module 20 may not display the keywords of the user search query (i.e., essentially the user search query itself), but may only display ranked search results delivered by the server 200 to the user computing device 100. In another embodiment of the present invention, the display module 20 may display only the keywords of the user search query (i.e., essentially the user search query itself), but may not display ranked search results delivered by the server 200 to the user computing device 100.

It should be noted that displaying search results obtained by the user computing device 100 in ranked form over the communication network 300 from the server 200 on the display module 20 under the control of the computing module 40 provides the best conformance (highest degree of relevance) of said search results to the user search query (i.e., the user's needs for obtaining specific information) and substantially simplifies the process of searching by the user for target information among said ranked search results.

### User Interaction Module

The user interaction module 30 shown in FIG. 1 as part of the user computing device 100 is connected via the communication bus 50 to the computing module 40 described below and to the display module 20 described above with the capability of data exchange with them.

The user interaction module 30 can be implemented, for example, as any suitable input device, such as a keyboard, mouse-type manipulator, microphone, camera, joystick, game console or any other suitable input device known in the prior art and allowing the user to enter or transmit their user search query to the user computing device 100, wherein such a suitable input device may be part of the user computing device 100 or may be connected to the user computing device 100 using the communication module 10.

The user interaction module 30 is configured such that it provides the capability for entering or transmitting by the user a user search query containing one or more search keywords corresponding to the user's need to find or collect target information.

It should be noted that the user search query may contain keywords for implementing metasearch directed, for example, at finding needed goods, a flight, a hotel, a rental car, a restaurant, an auto service center, a cinema, a theater or any other good/service of interest to the user. Furthermore, the user search query may contain keywords for implementing metasearch directed at identifying the price of a specific good or specific service, identifying a point (location) of market implementation of a specific good or specific service, or identifying any parameter or any characteristic of interest to the user inherent in a specific good or specific service. It should also be noted that the keywords in the user search query entered or transmitted by the user using the user computing device 100 can be compiled using any of the known languages in the world, for example, English, Russian, Chinese, Arabic, Japanese, Spanish, German, Italian or the like.

In an embodiment of the present invention in which the user interaction module 30 represents a keyboard, the user can enter through the keyboard keys a user search query which can be additionally displayed on the display module 20 as a static or dynamic image or which can be delivered to the user through a speaker of the computing device 100 as an audio signal.

In one embodiment of the present invention, the user computing device 100 may lack a user interaction module 30, and the display module 20 can be implemented as a touch display module or touch display, so the user can enter through on-screen buttons or on-screen keyboard keys pressed by the user's fingers a user search query which can be additionally displayed on the display module 20 as a static or dynamic image or which can be additionally delivered to the user through a speaker of the computing device 100 as an audio signal. Thus, in this embodiment of the present invention, the display module 20 can perform all functional capabilities of the user interaction module 30, so in case the display module 20 is implemented as a touch display module or touch display it acquires the functions of the user interaction module. In one variation of this embodiment of the present invention, the user computing device 100 may include only a user interaction module implemented as a touch display module or touch display and having simultaneously the functional capabilities of the user interaction module 30 described in this document and the functional capabilities of the display module 20 described in this document.

In another embodiment of the present invention in which the user interaction module 30 represents a mouse-type manipulator, the user can enter through on-screen keyboard keys pressed using said manipulator a user search query which can be additionally displayed on the display module 20 or which can be additionally delivered to the user through a speaker of the computing device 100 as an audio signal.

In yet another embodiment of the present invention in which the user interaction module 30 represents a camera built into the housing of the user computing device 100 or connected to the user computing device 100 via the communication module 10, the user can enter or transmit a user search query which can be additionally displayed on the display module 20 or which can be additionally delivered to the user through a speaker of the computing device 100 as an audio signal by using predefined gestures to specify search keywords that the user should show (for example, using fingers or hands) and that should be captured in the field of view of said camera. In such an embodiment of the present invention, the camera must capture images in continuous or real-time mode, wherein an image captured by the camera containing the user's body or part of it (i.e., the user's fingers or hands) must be directed or transmitted by said camera to the computing module 40 for its subsequent processing, in particular to establish the fact of whether said captured image contains a gesture corresponding to one of the predefined gestures known to the computing module 40 and correlated each with, for example, one of the designated letters of the alphabet of the language in which the user wants to form their user search query, or in accordance with one or more words with which the user wants to form their user search query. As an alternative, in this embodiment of the present invention, instead of a given set of gestures, the user can similarly use any conventional user signals demonstrated by the user in the field of view of the camera, for example, predefined body movements/positions or parts thereof, predefined lip movements/positions, predefined eye movements/blinks and the like.

In another embodiment of the present invention in which the user interaction module 30 can be implemented as a microphone built into the housing of the user computing device 100 or connected to the user computing device 100 via the communication module 10, the user can enter or transmit a user search query which can be additionally displayed on the display module 20 or which can be additionally delivered to the user through a speaker of the computing device 100 as an audio signal by pronouncing aloud one or more search keywords forming the user search query, wherein said user-pronounced search keywords must be captured by said microphone in real time, and the audio signal captured by the microphone must be directed or transmitted by said microphone to the computing module 40 as a stream of digital data for its subsequent processing, in particular to extract by the computing module 40 said search keywords from said stream of digital data using one of the technologies known to a person skilled in the art.

It should be noted that the user interaction module 30 can be used by the user not only to enter or transmit their user search queries, but to control the metasearch data process, for example, to eliminate errors that may arise during the operation of at least one of the functional modules included in the user computing device 100 when implementing said metasearch data process using the user computing device 100.

In one embodiment of the present invention, the user computing device 100 can also contain a separate analyzing module (not shown) for analyzing input data (may also be called a data preprocessing module, filtering module, identifying module, scanning module, recognizing module or the like), connected to the communication module 10 via the communication bus 50 with the capability of receiving from the communication module 10 a packet/stream of data containing a user search query in a specified language (i.e., at least one search keyword in a language known to the user). In particular, it should be noted that the packet/stream of data received by the communication module 10 from one of the external functional devices for user interaction connected in a wired or wireless manner to the communication module 10 and relating to a specific user search query entered or transmitted by the user using said external functional device for user interaction, contains not only digital data of the set of search keywords in a language known to the user forming said user search query and a unique identifier of the user search query, but also identification data of the data stream itself describing the transmitted data stream, for example, the date and time of sending, identification data of the sender in the form of, for example, a unique identifier of the external functional device, identification data of the receiver in the form of, for example, a unique identifier of the user computing device, and/or other necessary attributes of such transmitted data stream providing the possibility of identifying said data stream on the side of the user computing device 100. Furthermore, the aforementioned analyzing module of the user computing device 100 must be pre-programmed or configured to process various data streams received by the communication module 10 to identify the data stream from any of the external functional devices for user interaction (not shown) that may be connected to the user computing device 100 via the communication module 10 and that may be used by the user to enter or transmit their user search query (in particular, by detecting the matching of stream identification data with one of the unique identifiers of external functional devices known to the analyzing module and stored, for example, in the local data storage 60 to which such analyzing module can be connected via the communication bus 50), to extract necessary data for the user computing device 100 to implement its functional capabilities described in this document during metasearch of data. Furthermore, such analyzing module of the user computing device 100 can be additionally configured to extract one or more search keywords forming the user search query and identification data describing this user search query from the packet/stream of data received by the user computing device 100 from one of the external functional devices for user interaction (not shown), wherein said analyzing module must at least know the format of recording of the processed data streams, which is usually a string of characters with standard keywords to indicate the type of information. In particular, the analyzing module of the user computing device 100 should know that a standard keyword in the received string of characters indicating the beginning of the text of the user search query is, for example, the word “text”. It should also be noted that in order for the analyzing module of the user computing device 100 to extract from the data stream received by the user computing device 100 from one of the external functional devices for user interaction (in addition to the extracted text of the user search query) all necessary identification data describing the extracted user search query, such as the date and time of sending, identification data of the sender, identification data of the receiver and/or other identifiers, said analyzing module must also know other standard keywords commonly used in received character strings to indicate the presence of those or other identification information following this keyword in these character strings. It should also be noted that the analyzing module of the user computing device 100 must be pre-programmed or configured such that it knows the unified format of data description with which the user computing device 100 works, wherein as such a unified format a text format of data description can be used.

In one variation of this embodiment of the present invention, the data stream received by the user computing device 100 from one of the external functional devices for user interaction via the communication module 10 may represent an audio stream, and said external functional device may represent a smart speaker, microphone, smart television or similar device known in the prior art and configured to record or register the user's voice command or voice message. In such a variation of this embodiment of the present invention, the analyzing module of the user computing device 100 can be additionally configured to convert voice/sound to text (for example, using known dynamic temporal algorithms, known methods of context-dependent classification based on extracting from the speech stream individual lexical elements, such as phonemes and allophones, with their subsequent combination into syllables and morphemes, known methods of discriminant analysis based on Bayesian discrimination, methods based on hidden Markov models, methods based on neural networks and the like) with provision for the possibility of identifying in said text one or more search keywords forming the user search query.

In another variation of this embodiment of the present invention, the data stream received by the user computing device 100 from one of the external functional devices for user interaction via the communication module 10 may represent a video stream, and said external functional device may represent a video camera, IP camera, smart television with a built-in video camera or similar device known in the prior art and configured to capture the user's image in real time or near real time. In such a variation of this embodiment of the present invention, the analyzing module of the user computing device 100 can be additionally configured to convert video/video stream to text (for example, using the “Virtual Audio Cable” software product which is one of the known transcription means), the capability to recognize text in video/video stream (for example, using the “ABBY Real-time Recognition SDK” software product), the capability to recognize objects in video/video stream with provision for their conversion to text (for example, using the “Cloud Video Intelligence IP” cloud service), and/or the capability to recognize actions in video/video stream with provision for their conversion to text (for example, using the same “Cloud Video Intelligence IP” cloud service) with provision for the possibility of identifying in said text one or more search keywords forming the user search query.

In yet another variation of this embodiment of the present invention, the user computing device 100 can contain two or more analyzing modules, each of which can be configured to implement at least one of the aforementioned functional capabilities, namely the capability to convert audio data to text data, the capability to convert video data to text data, and the capability to process text data to extract one or more search keywords forming the user search query. In another variation of this embodiment of the present invention, the analyzing module of the user computing device 100 can be divided into several separate analyzing or converting modules, each of which can be configured to implement at least one of the aforementioned functional capabilities of the analyzing module of the user computing device 100.

In another embodiment of the present invention, the functional capabilities of the analyzing module of the user computing device 100 disclosed in the aforementioned additional embodiments of the present invention can be implemented (alternatively) by the computing module 40 described below connected to the communication module 10 via the communication bus 50.

Thus, the user interaction module 30 included in the user computing device 100 is configured to enable user interaction to allow entering or transmitting by the user a user search query containing one or more search keywords describing the goal or object of the user's search.

### Computing Module

The computing module 40 shown in FIG. 1 as part of the user computing device 100 is connected via the communication bus 50 to the communication module 10, the display module 20, the user interaction module 30 and the local data storage 60 with the capability of data exchange with them.

The computing module 40 can be implemented, for example, as one separate processor, such as a general-purpose processor, special-purpose processor and/or the like, wherein such a processor can have either a single computing core or multiple jointly functioning computing cores. Alternatively, the computing module 40 can be implemented as one or more interacting processors.

The computing module 40 is configured to manage the operation of the display module 20 through a graphics processor or video card with provision for the possibility of displaying data described above in this document with respect to the display module 20, and is configured to manage the operation of the communication module 10.

Furthermore, the computing module 40 is configured to implement operations described below necessary for implementing metasearch of data in one or more information sources, in particular in the first and second information sources 400, 500.

Furthermore, the computing module 40 provides the capability to record or store in the local data storage 60 (depending on the embodiment, as described above in this document in a separate local data storage using the communication bus 50 and/or server 200 using the communication module 10 connected to the communication bus 50) to which the computing module 40 can gain access via the communication bus 50, at least one of the following data: user search queries received by the user interaction module 30, network addresses of information resources received from the server 200, search queries formed by the computing module 30 in accordance with network addresses of information resources, search results received from information resources 400, 500 in response to search queries, and ranked search results. In some embodiments of the present invention, the computing module 40 additionally provides the capability to record or store in the local data storage 60 (depending on the embodiment, as described above in this document in a separate local data storage using the communication bus 50 and/or server 200 using the communication module 10 connected to the communication bus 50) to which the computing module 40 can gain access via the communication bus 50, at least one of the following data: authorization data for user authorization on information resources, and data about authorization keys received from information resources in response to authorization requests, data of authorization requests directed to information resources 400, 500.

The computing module 40 thanks to its connection to the user interaction module 30 with the capability of data exchange is configured to receive from it a user search query which can be provided by the user interaction module 30 to the computing module via the communication bus 50.

Furthermore, the computing module 40 thanks to its connection to the display module 20 is additionally configured to enable displaying of the user search query received from the user interaction module 30 on the display module 20 as a static image, dynamic image or text message.

Furthermore, the computing module 40 is configured to enable initiating or creating a secure connection between the user computing device 100 and the server 200 connected to each other via the communication network 300 with the capability of data exchange using any suitable point-to-point protocol (i.e., any suitable PPTP protocol) which essentially allows the user computing device 100 (via the communication module 10) and the server 200 to exchange data with each other over the communication network 300 using a secure communication channel. In particular, the computing module 40 enables the capability to transmit the user search query received by the computing module 40 from the user interaction module 30 via the communication bus 50 over the secure connection created between the user computing device 100 and the server 200 to said server 200. It should be noted that the secure connection created by the user computing device 100 within the communication network 300 for exchanging data between the server 200 and the user computing device 100 can also be called in the prior art a tunnel connection or tunnel.

Furthermore, the computing module 40 is configured to enable receiving from the server 200 one or more network addresses of information resources (for example, first and second information resources 400, 500) over the secure connection created between the user computing device 100 and the server 200, wherein said network addresses of information resources are essentially delivered by the server 200 to the user computing device 100 in the form of control instructions or commands over said secure connection in response to said user search query received by the server 200 from the user computing device 100 over said secure connection with provision for its subsequent processing. Thus, the control instructions or commands containing network addresses of information resources and delivered by the server 200 to the user computing device 100 essentially represent the result of processing by the server 200 of the user search query, wherein said network addresses of information resources essentially correspond to said user search query, in particular correspond to one or more of the search keywords forming said user search query.

The computing module 40 is also configured to enable transmitting at least one search query over the communication network correlated with a unique identifier of the user computing device (for example, the IP address of the user computing resource) to at least one or each of the information resources using a respective network address obtained from the server 200 over the secure connection. In particular, the computing module 40 can transmit a search query to one or each of the first and second information resources 400, 500, wherein each such search query of the user computing device 100 must be correlated with a unique identifier of the user computing device (for example, the IP address of the user computing resource). It should be noted that any of the first and second information resources 400, 500 upon receiving the corresponding search query of the user computing device 100 automatically identifies said search query as a request originating from the user computing device 100 (rather than from the server 200) which will actually be the source of said search query for said information resource.

Thus, the user computing device 100, in particular the computing module 40, essentially becomes a functional intermediary between the server 200 and the information resources 400, 500 or essentially acquires the functional capabilities of a proxy server for the server 200, which allows the server 200 to anonymously participate through the user computing device 100 in transmitting search queries to said information resources 400, 500, which identify said search queries as originating from the user computing device 100 (i.e., from a real user rather than from a bot, aggregator, scraper or backend server). Such an approach according to which search queries are ultimately transmitted to information resources in accordance with their network addresses from the user computing device 100 in response to control commands of the server 200 rather than from the server 200 itself allows eliminating the possibility of blocking the source of search queries (i.e., the user computing device 100) on the side of at least one or each of the information resources 400, 500, since said information resource when receiving and processing each such search query automatically identifies it as a search query of a real user based on the IP address of the user computing device 100 contained in said search query and in no way associates said search query with a bot, aggregator, scraper or backend server which could lead to blocking of such search query and blocking of the source of such search query.

In one embodiment of the present invention, the computing module 40 can be configured to enable receiving from the server 200 one or more server search queries which must be provided to information resources (for example, to the first and second information resources 400, 500) in accordance with their network addresses identified by the server 200 in processing the user search query received from the user computing device 100 over the secure connection created between the user computing device 100 and the server 200. Thus, in this embodiment of the present invention, server search queries are delivered by the server 200 to the user computing device 100 over the secure connection created between the user computing device 100 and the server 200 in response to the user search query received by the server 200 from the user computing device 100 over said secure connection with provision for its subsequent processing, wherein each of said server search queries essentially corresponds to the user search query. It should be noted that in this embodiment of the present invention, the user computing device 100 essentially duplicates said server search queries by redirecting them to the corresponding information resources (for example, to the first and second information resources 400, 500) in accordance with their network addresses contained in the data stream from the server 200 which the server 200 delivers to the user computing device 100 when delivering to it said server search queries and which the user computing device 100 identifies as a result of processing said server search queries.

The computing module 40 is also configured to enable receiving search results from information resources (for example, from the first and second information resources 400, 500) to which search queries were previously transmitted by the computing module 40 with provision for the possibility of their redirect to the server 200 over the secure connection created between the user computing device 100 and the server 200, wherein said search results are transmitted from said information resources to the user computing device 100 over the communication network 300.

Thus, such an approach according to which search queries are ultimately transmitted to information resources in accordance with their network addresses from the user computing device 100 in response to control commands of the server 200 rather than from the server 200 itself also allows obtaining search results which will be most relevant to the user who initially entered or transmitted the user search query or which will most accurately correspond to the goals, objectives or essence of the user search query, since search results delivered by information resources 400, 500 to the user computing device 100 in response to search queries from the user computing device 100 often depend on at least the geographical location of the user and/or the history of user search queries on a particular information resource determined by each of such information resources based on the IP address of the user computing device 100 contained in the data stream delivered by the user computing device 100 to said information resource when transmitting the corresponding search query to it.

The computing module 40 is also configured to enable receiving ranked search results from the server 200 over the aforementioned secure connection created by the computing module 40 for implementing or organizing data exchange between the user computing device 100 and the server 200.

In one embodiment of the present invention, the computing module 40 in the user computing device 100 can be configured to enable processing of search results received over the communication network 300 from information resources (for example, first and second information resources 400, 500) by ranking them (alternatively classifying or filtering) in accordance with a specified computer ranking model which allows obtaining ranked search results which are most relevant to the user, for example most corresponding to user preferences. In one variation of this embodiment of the present invention, the computing module 40 in the user computing device 100 can be additionally configured to enable delivery of ranked search results to the display module 20 via the communication bus 50 with provision for, for example, their display on the display module 20. Thus, in this embodiment of the present invention, the user computing device 100 does not transmit search results obtained over the communication network 300 from information resources (for example, first and second information resources 400, 500) to which search queries were previously provided to the server 200 for their subsequent ranking on the server side but implements said ranking operation independently.

In another embodiment of the present invention, the computing module 40 in the user computing device 100 can be additionally configured to enable initiating or creating a hidden web browser process (for example, using the “WebView” software) to transmit through it search queries of the user computing device 100 to corresponding information resources (for example, first and second information resources 400, 500) and with the capability of receiving search results from information resources to which search queries of the user computing device 100 were transmitted through said initiated hidden web browser process, which essentially allows receiving search results from information resources such as information resources 400, 500 anonymously.

In some embodiments of the present invention, ranked search results can be delivered to the user under the control of the computing module 40 in the form of an audio message generated by a speaker (not shown) which can be additionally built into the user computing device 100.

In other embodiments of the present invention, ranked search results can be delivered to the user under the control of the computing module 40 in the form of a vibration signal generated by a vibration motor (not shown) which can be additionally built into the user computing device 100.

In other embodiments of the present invention, ranked search results can be delivered to the user under the control of the computing module 40 in the form of a tactile signal created using a tactile element built into the housing of the user computing device 100 or the display module 20 and having a tactilely distinguishable parameter selected from a group containing: height or extent of the tactile element, thickness of the tactile element, shape of the tactile element, rigidity of the tactile element, temperature of the tactile element, roughness of the tactile element, frequency of vibration of the tactile element, degree of displacement of the tactile element, angle of rotation of the tactile element and angle of inclination of the tactile element.

In other embodiments of the present invention, the aforementioned functional capabilities of the computing module 40 can be implemented by a processor included in the user computing device 100.

In some other embodiments of the present invention, the computing module 40 can be divided into several independent modules, each of which can perform at least one of the functional capabilities described in this document with respect to the computing module 40 and which can be configured to communicate with each other and with the other functional modules of the computing device 100 using the communication bus 50.

According to one embodiment of the present invention, the user interaction module 30 included in the user device 100 can be additionally configured to enable entering or transmitting by the user of authorization data (authentication data) for one or more information resources (for example, for the first and second information resources 400, 500), and the computing module 40 included in the user device 100 can be additionally configured to enable implementation of at least the following operations according to which:

(i) said authorization data are transmitted to the server 200 over the secure connection created between the user computing device 100 and the server 200,

(ii) one or more server authorization requests are received from the server 200, each corresponding to the user search query and corresponding to one of said information resources (for example, one of the first and second information resources 400, 500) for which authorization data were transmitted to the server 200, over said secure connection with provision for issuing a user authorization request to each of the information resources (for example, to each of the first and second information resources 400, 500) corresponding to said server authorization requests over the communication network 300 and

(iii) authorization keys (i.e., authentication keys or authentication keys representing unique identifiers for user authentication on specific information resources) are received from said information resources (for example, from the first and second information resources 400, 500) to which user authorization requests were issued over the communication network 300 with provision for their delivery to the server 200 over said secure connection, wherein in such embodiment of the present invention

the network addresses of information resources in the communication network 300 (for example, network addresses for the first and second information resources 400, 500) received from the server 200 additionally correspond to said authorization keys, and

each search query, transmitted by the user computing device 100 over the communication network 300 to an information resource (for example, first information resource 400 or second information resource 500) in accordance with one of said information resource addresses (for example, one of the network addresses for the first and second information resources 400, 500), additionally contains an authorization key corresponding to said information resource.

It should be noted that authorization data entered or transmitted by the user via the user interaction module 30 may contain, for example, a username (login) and password for authorization on a specific information resource (for example, an online store website, airline website, hotel website, restaurant website, auto service website or the like) which further, namely when generating through said information resource search results in response to a specific user search query received from the user computing device 100 over the communication network 300 and corresponding to a specific user who entered or transmitted said user search query via the user computing device 100 allows taking into account at least part or all of the user's preferences, the user's order history, the user's bonuses, the user's memorable dates or other data characteristic only of said user and stored on a storage device which said information resource accesses when receiving a search query, so that said search results delivered by said information resource to the user computing device 100 over the communication network 300 will be more personalized or more relevant to said specific user.

According to another embodiment of the present invention, the user interaction module 30 included in the user device 100 can be additionally configured to enable entering or transmitting by the user of authorization data (authentication data) for one or more information resources (for example, for the first and second information resources 400, 500), and the computing module 40 included in the user device 100 can be additionally configured to enable implementation of at least the following operations according to which:

(i) user authorization is implemented on each of said information resources (for example, each of the first and second information resources 400, 500) over the communication network 300 using said authorization data which are contained in each of the corresponding authorization requests transmitted by the user computing device 100 over the communication network 300 to each of the information resources (for example, to each of the first and second information resources 400, 500) corresponding to said authorization data, and

(ii) authorization keys are received from said information resources (for example, from the first and second information resources 400, 500) over the communication network 300 with provision for their delivery to the server 200 over the secure connection created between the user computing device 100 and the server 200, wherein in such embodiment of the present invention

the network addresses of information resources in the communication network 300 (for example, network addresses for the first and second information resources 400, 500) received from the server 200 additionally correspond to said authorization keys, and

each search query, transmitted by the user computing device 100 over the communication network 300 to an information resource (for example, first information resource 400 or second information resource 500) in accordance with one of said information resource addresses (for example, one of the network addresses for the first and second information resources 400, 500), additionally contains an authorization key corresponding to said information resource.

In one variation of such another embodiment of the present invention, the computing module 40 included in the user computing device 100 can be additionally configured to enable initiating a hidden web browser process to implement the aforementioned user authorization process.

In another variation of such another embodiment of the present invention, the computing module 40 included in the user computing device 100 can be additionally configured to enable transmitting each aforementioned search query to the corresponding information resource (for example, to the first or second information resource 400, 500) via the hidden web browser process previously initiated or created by the user computing device 100 and can be configured to enable receiving search results from information resources (for example, from the first and second information resources 400, 500) to which search queries from the user computing device 100 were transmitted through said initiated hidden web browser process.

### Server for Implementing Meta-Search of Data

The server 200 for implementing metasearch of data shown in FIG. 1 essentially represents a backend server configured to manage network addresses of information resources previously stored on a storage device of the server 200.

The server 200 can be implemented, for example, as a single computer server, such as a “Dell™ PowerEdge™” server using for example an operating system “Linux Ubuntu Server” (any versions and modifications), “Microsoft Windows Server” (any versions and modifications) or “OS X Server” (any versions and modifications).

In some embodiments of the present invention, the server 200 may have or may gain access to at least one remote or external database (not shown) over the communication network 300 or in another (wired or wireless) manner to extract data necessary for implementing functional operations (capabilities) described in this document with respect to the server 200.

The server 200 is configured to receive the user search query transmitted by the user computing device 100 over the secure connection created by the user computing device 100 to implement data exchange between the user computing device 100 and the server 200 over the communication network 300.

Furthermore, the server 200 is configured to process the user search query received from the user computing device 100 with provision for the possibility of analyzing one or more search keywords forming said user search query to identify network addresses of information resources corresponding to said user search query. Thus, as a result of processing the user search query received from the user computing device 100, the server 200 can, for example, determine that said user search query corresponds to network addresses at which the first and second information resources 400, 500 are located.

Furthermore, the server 200 is configured to form control instructions or commands containing one or more network addresses of information resources corresponding to the user search query and identified by the server 200 as a result of processing the user search query, and with the capability of delivering said formed control commands to the user computing device 100 over the secure connection created between the user computing device 100 and the server 200.

Thus, the network addresses of information resources contained in the control commands of the server 200 transmitted by the server 200 to the user computing device 100 essentially represent the result of processing by the server 200 of the user search query, wherein said network addresses of information resources essentially correspond to said user search

As an alternative, the server 200 can be pre-programmed or configured to deliver a designated set of network addresses of information resources, for example one or more network addresses of information resources to the user computing device 100 over the secure connection created between the user computing device 100 and the server 200 in response to the user search query (i.e., upon receipt by the server 200 of the user search query).

As another alternative, the server 200 can be configured to form one or more server search queries which must be delivered to information resources (for example, to the first and second information resources 400, 500) in accordance with their network addresses identified by the server 200 in processing the user search query received from the user computing device 100 over the secure connection created between the user computing device 100 and the server 200, and with the capability of delivering said formed server search queries to the user computing device 100 over said secure connection for their subsequent processing in the user computing device 100, wherein each of said server search queries essentially corresponds to the user search query.

The server 200 is also configured to receive search results delivered by information resources from the user computing device 100 over the secure connection created between the user computing device 100 and the server 200.

Furthermore, the server 200 is configured to process the search results received from the user computing device 100 over the secure connection created between the user computing device 100 and the server 200 by ranking them (alternatively classifying, normalizing or filtering) in accordance with a specified computer ranking model which allows obtaining ranked search results which are most relevant to the user, for example most corresponding to user preferences.

Furthermore, the server 200 is configured to deliver ranked search results to the user computing device 100 over the secure connection created between the user computing device 100 and the server 200 with provision for, for example, their display on the display module 20 in the user computing device 100.

According to one embodiment of the present invention in which the user computing device 100 is configured to enable entering or transmitting by the user of authorization data for one or more information resources (for example, for the first and second information resources 400, 500), the server 200 can be additionally configured to enable implementation of at least the following operations or steps according to which:

(i) authorization data transmitted by the user computing device 100 over the secure connection created by the user computing device 100 for implementing data exchange between the user computing device 100 and the server 200 over the communication network 300 are received from the user computing device 100,

(ii) said received authorization data are processed to generate or create one or more server authorization requests, each corresponding to the user search query and corresponding to one of the information resources (for example, one of the first and second information resources 400, 500) for which authorization data were transmitted to the server 200,

(iii) said generated server authorization requests are transmitted or delivered to the user computing device 100 over said secure connection, and

(iv) authorization keys for information resources (for example, for the first and second information resources 400, 500) received by the user computing device 100 over the communication network 300 from said information resources in response to a user authorization request to each of the information resources corresponding to said server authorization requests are received over said secure connection from the user computing device 100, wherein said authorization keys for authorization on information resources essentially correspond to said server authorization requests and the network addresses of information resources in the communication network 300 received by the user computing device 100 from the server 200 in the aforementioned manner additionally correspond to said authorization keys received by the server 200 from the user computing device 100 over the aforementioned secure connection.

According to another embodiment of the present invention in which the user computing device 100 is configured to enable entering or transmitting by the user of authorization data for one or more information resources (for example, for the first and second information resources 400, 500), the server 200 can be additionally configured to enable implementation of at least the following operations or steps according to which:

(i) authorization keys for information resources (for example, for the first and second information resources 400, 500) received by the user computing device 100 over the communication network 300 from said information resources when implementing user authorization on said information resources (i.e., in response to a user authorization request to each of the information resources corresponding to the user authorization data) are received over the secure connection created between the user computing device 100 and the server 200 from the user computing device 100, wherein said authorization keys for authorization on information resources essentially correspond to said authorization data and the network addresses of information resources in the communication network 300 received by the user computing device 100 from the server 200 in the aforementioned manner additionally correspond to said authorization keys received by the server 200 from the user computing device 100 over the aforementioned secure connection.

### Methods for Implementing Meta-search of Data

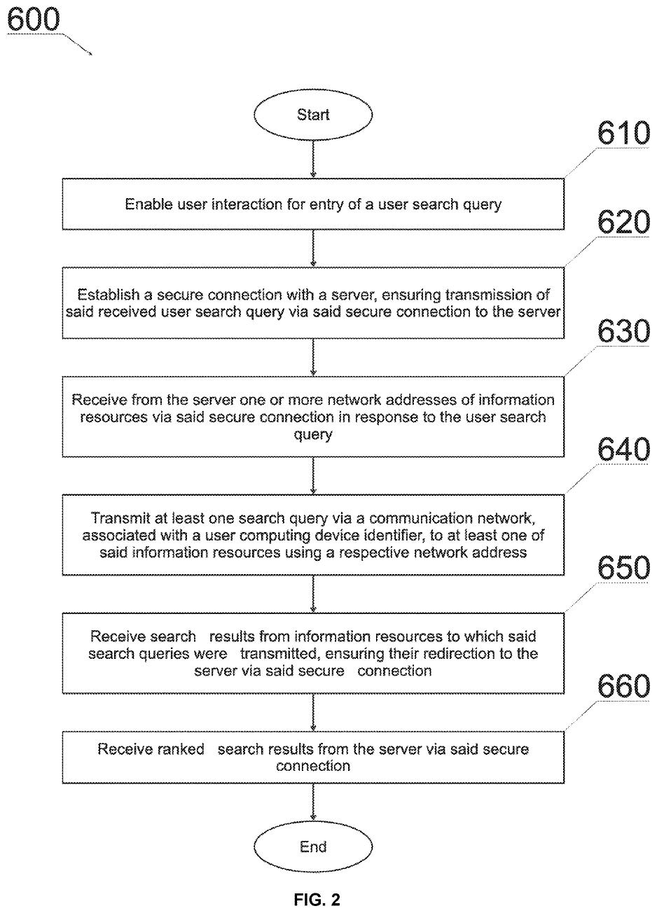

FIG. 2 shows a flowchart illustrating the main operations of a method 600 for implementing metasearch of data according to the present invention.

The method 600 for implementing metasearch of data shown in FIG. 2 can be implemented using the computing device 100 according to the present invention shown in FIG. 1 as part of the system 1000 for implementing metasearch of data.

Furthermore, the method 600 for implementing metasearch of data shown in FIG. 2 can also be implemented using any suitable known computing or computer device containing one or more processors and equipped with a display module or display including using the aforementioned general-purpose computer containing a central processor and equipped with a display (i.e., connected to a display device).

Thus, it should be obvious to a person skilled in the art that as a computing device used to perform at least part of the operations described below of the method 600 for implementing metasearch of data according to the present invention, the user computing device 100 or any other suitable computing device known in the prior art can be used. Furthermore, it should be obvious to a person skilled in the art that as a storage device used to store the results of performing at least part of the operations described below of the method 600 for implementing metasearch of data according to the present invention and/or used to extract data necessary for performing at least part of the operations described below of the method 600 for implementing metasearch of data according to the present invention, the local data storage 60, the storage device of the server 200 and/or any other suitable storage device known in the prior art can be used. It should also be obvious to a person skilled in the art that as a display module used to display the results of performing at least part of the operations described below of the method 600 for implementing metasearch of data according to the present invention, the display module 20, any other suitable display known in the prior art, or any other suitable visualization device known in the prior art can be used. It should also be obvious to a person skilled in the art that user interaction with the computing device used to perform at least part of the operations described below of the method 600 for implementing metasearch of data according to the present invention can be implemented, for example, using standard input/output means of the user computing device using the capability of the display module of the user computing device to register a piezoelectric effect when implemented as a touch display or in any other suitable manner described in this document or known in the prior art.

The method 600 for implementing metasearch of data shown in FIG. 2 includes six (6) following main operations or steps according to which:

(610) provision is made through the user computing device 100 for enabling user interaction to allow a user to input a user search query,

(620) a secure connection is created through the user computing device 100 with the server 200 with provision for transmission of said received user search query over said secure connection with the server 200,

(630) one or more network addresses of information resources (for example, first and second information resources 400, 500) are received through the user computing device 100 from the server 200 over said secure connection in response to said user search query,

(640) at least one search query is transmitted through the user computing device 100 over the communication network, correlated with an identifier of the user computing device, to at least one of said information resources (for example, first and second information resources 400, 500) using a respective network address,

(650) search results are received through the user computing device 100 from the information resources (for example, from the first and second information resources 400, 500) to which search queries were transmitted with provision for their redirect to the server 200 over said secure connection, and

(660) ranked search results are received through the user computing device 100 from the server 200 over said secure connection.

In one embodiment of the present invention, in the method 600 for implementing metasearch of data shown in FIG. 2, instead of or in place of the aforementioned steps (650)-(660), alternative operations or steps can be implemented according to which: (i) search results are received through the user computing device 100 from the information resources (for example, from the first and second information resources 400, 500) to which search queries were transmitted, and (ii) said received search results are ranked through the user computing device 100 to obtain ranked search results.

In another embodiment of the present invention, the method 600 for implementing metasearch of data shown in FIG. 2 can additionally include the following main operations or steps according to which:

(i) provision is made through the user computing device 100 for enabling user interaction to allow transmission by the user of authorization data for one or more information resources (for example, for the first and second information resources 400, 500),

(ii) said authorization data are transmitted through the user computing device 100 to the server 200 over the secure connection created between the server 200 and the user computing device 100,

(iii) one or more server authorization requests are received through the user computing device 100 from the server 200, each corresponding to the user search query and corresponding to one of the information resources (for example, one of the first and second information resources 400, 500) for which authorization data were transmitted to the server 200, over said secure connection with provision for issuing a user authorization request to each of the information resources (for example, to each of the first and second information resources 400, 500) corresponding to said server authorization requests over the communication network 300, and

(iv) authorization keys are received through the user computing device 100 from the information resources (for example, from the first and second information resources 400, 500) to which user authorization requests were issued over the communication network 300 with provision for their delivery to the server 200 over said secure connection, wherein

(a) the network addresses of information resources in the communication network 300 (for example, network addresses for the first and second information resources 400, 500) received from the server 200 additionally correspond to said authorization keys, and

(b) each search query, transmitted by the user computing device 100 over the communication network 300 to an information resource (for example, to the first or second information resource 400, 500) in accordance with one of said information resource addresses, additionally contains an authorization key corresponding to said information resource.

In another embodiment of the present invention, the method 600 for implementing metasearch of data shown in FIG. 2 can additionally include the following main operations or steps according to which:

(i) provision is made through the user computing device 100 for enabling user interaction to allow transmission by the user of authorization data for one or more information resources (for example, for the first and second information resources 400, 500),

(ii) user authorization is implemented through the user computing device 100 on each of said information resources (for example, on each of the first and second information resources 400, 500) over the communication network 300 using said authorization data, and

(iii) authorization keys are received through the user computing device 100 from said information resources (for example, from the first and second information resources 400, 500) over the communication network 300 with provision for their delivery to the server 200 over said secure connection, wherein

the network addresses of information resources in the communication network 300 (for example, network addresses for the first and second information resources 400, 500) received from the server 200 additionally correspond to said authorization keys, and

each search query, transmitted by the user computing device 100 over the communication network 300 to an information resource (for example, to the first or second information resource 400, 500) in accordance with one of said information resource addresses (for example, one of the network addresses for the first and second information resources 400, 500), additionally contains an authorization key corresponding to said information resource.

In one variation of this another embodiment of the present invention, in the method 600 for implementing metasearch of data, a hidden web browser process is initiated or created through the user computing device 100 (for example, using the “WebView” software application) to implement user authorization.

In another variation of this another embodiment of the present invention, in the method 600 for implementing metasearch of data, each search query is transmitted through the user computing device 100 to the corresponding information resource (for example, to the first or second information resource 400, 500) through the hidden web browser process previously initiated or created by the user computing device 100 and search results from the information resources (for example, from the first and second information resources 400, 500) to which search queries were transmitted are received through said initiated hidden web browser process.

In another embodiment of the present invention, the method 600 for implementing metasearch of data shown in FIG. 2 can additionally include the following main operations or steps according to which:

(i) a hidden web browser process is initiated through the user computing device 100 (for example, using the “WebView” software application) to transmit each search query to the corresponding information resource (for example, to the first or second information resource 400, 500) over the communication network 300 through said initiated hidden web browser process, and

(ii) search results are received through the user computing device 100 from the information resources (for example, from the first and second information resources 400, 500) to which search queries were transmitted through said initiated hidden web browser process.

In another embodiment of the present invention, the method 600 for implementing metasearch of data can additionally include a further step according to which ranked search results are displayed on the display module 20 in the user computing device 100 or on an external display device (not shown) connected to the user computing device 100 over the communication network 300.

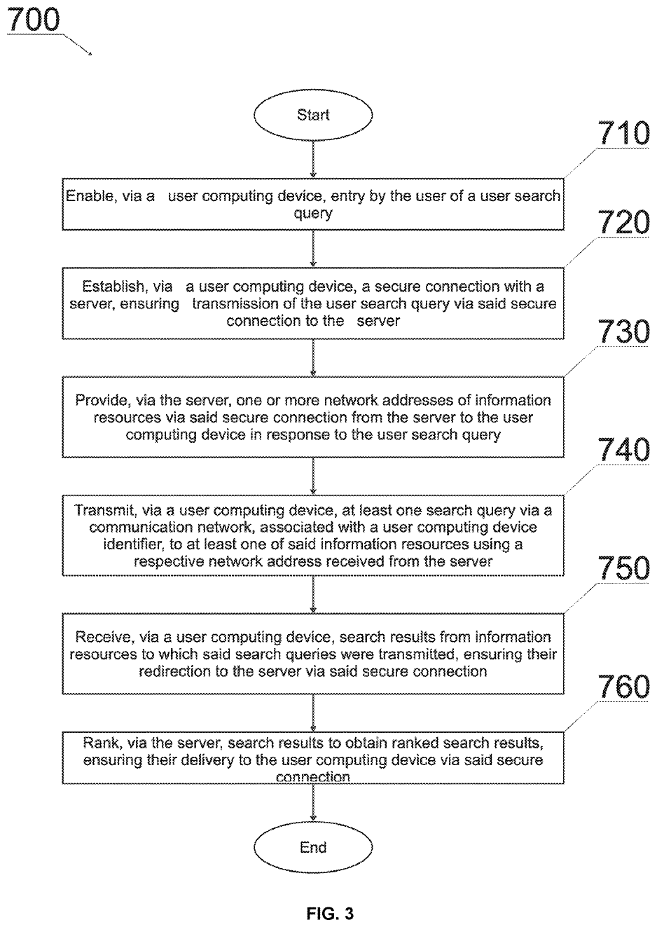

FIG. 3 shows a flowchart illustrating the main operations of a method 700 for implementing metasearch of data according to the present invention.

The method 700 for implementing metasearch of data shown in FIG. 3 can be implemented using the system 1000 for implementing metasearch of data according to the present invention shown in FIG. 1.

The method 700 for implementing metasearch of data shown in FIG. 3 includes six (6) following main operations or steps according to which:

(710) provision is made through the user computing device 100 for enabling a user to input a user search query,

(720) a secure connection is created through the user computing device 100 with a server with provision for transmission of said user search query over said secure connection with the server 200,

(730) one or more network addresses of information resources (for example, network addresses for the first and second information resources 400, 500) are provided through the server 200 over said secure connection from the server 200 to the user computing device 100 in response to said user search query,

(740) at least one search query is transmitted through the user computing device 100 over the communication network 300, correlated with an identifier of the user computing device, to at least one of said information resources (for example, to one of the first and second information resources 400, 500) using a respective network address received from the server 200,

(750) search results are received through the user computing device 100 from the information resources (for example, from the first and second information resources 400, 500) to which search queries were transmitted with provision for their redirect to the server 200 over said secure connection, and

(760) said search results are ranked through the server 200 to obtain ranked search results with provision for their delivery to the user computing device 100 over said secure connection.

In one embodiment of the present invention, in the method 700 for implementing metasearch of data shown in FIG. 3, instead of or in place of the aforementioned steps (750)-(760), alternative operations or steps can be implemented according to which: (i) search results are received through the user computing device 100 from the information resources (for example, from the first and second information resources 400, 500) to which search queries were transmitted, and (ii) said search results are ranked through the user computing device 100 to obtain ranked search results.

In another embodiment of the present invention, the method 700 for implementing metasearch of data shown in FIG. 3 can additionally include the following main operations or steps according to which:

(i) provision is made through the user computing device 100 for enabling transmission by the user of authorization data for one or more information resources (for example, for the first and second information resources 400, 500),

(ii) said authorization data are transmitted through the user computing device 100 to the server 200 over the secure connection created between the user computing device 100 and the server 200,

(iii) said authorization data are processed through the server 200 to create one or more server authorization requests, each corresponding to the user search query and corresponding to one of said information resources (for example, one of the first and second information resources 400, 500) for which authorization data were transmitted to the server 200, with provision for delivery of said server authorization requests to the user computing device 100 over said secure connection, and

(iv) a user authorization request is provided through the user computing device 100 to each of the information resources (for example, one of the first and second information resources 400, 500) corresponding to said server authorization requests over the communication network 300, and

(v) authorization keys are received from said information resources (for example, from the first and second information resources 400, 500) to which user authorization requests were issued over the communication network 300 with provision for their delivery to the server 200 over said secure connection, wherein

(a) the network addresses of information resources in the communication network 300 (for example, network addresses for the first and second information resources 400, 500) received from the server 200 additionally correspond to said authorization keys, and

(b) each search query, transmitted by the user computing device 100 over the communication network 300 to an information resource (for example, first information resource 400 or second information resource 500) in accordance with one of said information resource addresses (for example, in accordance with one of the network addresses for the first and second information resources 400, 500), additionally contains an authorization key corresponding to said information resource.

In another embodiment of the present invention, the method 700 for implementing metasearch of data shown in FIG. 3 can additionally include the following main operations or steps according to which:

(i) provision is made through the user computing device 100 for enabling transmission by the user of authorization data for one or more information resources (for example, for the first and second information resources 400, 500),

(ii) user authorization is implemented through the user computing device 100 on each of said information resources over the communication network using said authorization data, and

(iii) authorization keys are received through the user computing device 100 from said information resources (for example, from the first and second information resources 400, 500) over the communication network 300 with provision for their delivery to the server 200 over the secure connection created between the user computing device 100 and the server 200, wherein

the network addresses of information resources in the communication network (for example, network addresses for the first and second information resources 400, 500) received from the server 200 additionally correspond to said authorization keys, and

each search query, transmitted by the user computing device 100 over the communication network 300 to an information resource (for example, first information resource 400 or second information resource 500) in accordance with one of said information resource addresses (for example, one of the network addresses for the first and second information resources 400, 500), additionally contains an authorization key corresponding to said information resource.

In one variation of this another embodiment of the present invention, in the method 700 for implementing metasearch of data, a hidden web browser process is initiated or created through the user computing device 100 (for example, using the “WebView” software application) to implement user authorization.

In another variation of this another embodiment of the present invention, in the method 700 for implementing metasearch of data, each search query is transmitted through the user computing device 100 to the corresponding information resource (for example, first information resource 400 or second information resource 500) through the hidden web browser process previously initiated or created by the user computing device 100, and search results from the information resources (for example, from the first and second information resources 400, 500) to which search queries were transmitted are received through said initiated hidden web browser process.

In another embodiment of the present invention, the method 700 for implementing metasearch of data shown in FIG. 3 can additionally include the following main operations or steps according to which:

(i) a hidden web browser process is initiated through the user computing device 100 (for example, using the “WebView” software application) to transmit each search query to the corresponding information resource (for example, to the first or second information resource 400, 500) over the communication network 300 through said initiated hidden web browser process, and

(ii) search results are received through the user computing device 100 from the information resources (for example, from the first and second information resources 400, 500) to which search queries were transmitted through said initiated hidden web browser process.

In another embodiment of the present invention, the method 700 for implementing metasearch of data can additionally include a further step according to which ranked search results are displayed on the display module 20 in the user computing device 100 or on an external display device (not shown) connected to the user computing device 100 over the communication network 300.

The illustrative embodiments, examples and descriptions presented serve solely to provide understanding of the substance of the claimed invention and are not limiting. Other possible embodiments will be apparent to a person skilled in the art from the description presented above. The scope of the present invention is limited only by the appended claims.

1. A method for performing data metasearch, executed on a user computing device with one or more processors, the method comprising:
enabling user interaction to allow a user to enter a user search query;
establishing a network connection with a server for transmitting the received user search query via the network connection with the server;
receiving from the server one or more network addresses of information resources via the network connection in response to the entered user search query;
transmitting at least one search query via a communication network, associated with a user computing device identifier, to at least one of the information resources using a respective network address;
receiving search results from information resources to which the search queries were transmitted, so as to redirect them to the server via the network connection, and
receiving ranked search results from the server via the network connection.

2. The method of claim 1, further comprising:
displaying the ranked search results on a display module of the user computing device.

3. The method of claim 1, further comprising:
enabling user interaction to allow a user to transmit authorization data for one or more information resources;
transmitting the authorization data to the server via the network connection;
receiving from the server one or more server authorization requests, each of which corresponds to the user search query and corresponds to one of the information resources, for which authorization data were transmitted to the server, via the network connection so as to issue a user authorization request to each of the information resources corresponding to the server authorization requests via the communication network, and
receiving authorization keys from the information resources to which the user authorization requests were issued via the communication network so as to transmit them to the server via the network connection, wherein
the addresses of information resources in the communication network, received from the server, additionally correspond to the authorization keys, and
each search query, transmitted by the user computing device via the communication network to an information resource in accordance with one of the information resource addresses, additionally contains an authorization key corresponding to the information resource.

4. The method of claim 1, further comprising:
enabling user interaction to allow a user to transmit authorization data for one or more information resources;
performing user authorization on each of the information resources via the communication network using the authorization data, and
receiving authorization keys from the information resources via the communication network so as to transmit them to the server via the network connection, wherein
the addresses of information resources in the communication network, received from the server, additionally correspond to the authorization keys, and
each search query, transmitted by the user computing device via the communication network to an information resource in accordance with one of the information resource addresses, additionally contains an authorization key corresponding to the information resource.

5. The method of claim 4, wherein a headless web browser process is initiated to perform user authorization.

6. The method of claim 5, wherein each search query is transmitted to the corresponding information resource via the initiated headless web browser process, and search results from information resources to which the search queries were transmitted are received via the initiated headless web browser process.

7. The method of claim 1, further comprising:
initiating a headless web browser process to transmit each search query to the corresponding information resource via the communication network through the initiated headless web browser process, and
receiving search results from information resources to which the search queries were transmitted via the initiated headless web browser process.

8. A method for performing data metasearch, executed on a user computing device with one or more processors, the method comprising:
enabling user interaction to allow a user to enter a user search query;
establishing a network connection with a server for transmitting the entered user search query via the network connection with the server;
receiving from the server one or more network addresses of information resources via the network connection in response to the entered user search query;
transmitting at least one search query via a communication network, associated with a user computing device identifier, to at least one of the information resources using a respective network address;
receiving search results from information resources to which the search queries were transmitted, and
ranking the received search results to obtain ranked search results;
further comprising:
enabling user interaction to allow a user to transmit authorization data for one or more information resources;
transmitting the authorization data to the server via the network connection;
receiving from the server one or more server authorization requests, each of which corresponds to the user search query and corresponds to one of the information resources, for which authorization data were transmitted to the server, via the network connection so as to issue a user authorization request to each of the information resources corresponding to the server authorization requests via the communication network, and
receiving authorization keys from the information resources to which the user authorization requests were issued via the communication network so as to transmit them to the server via the network connection, wherein
the addresses of information resources in the communication network, received from the server, additionally correspond to the authorization keys,
and each search query, transmitted by the user computing device via the communication network to an information resource in accordance with one of the information resource addresses, additionally contains an authorization key corresponding to the information resource.

9. The method of claim 8, further comprising:
displaying the ranked search results on a display module of the user computing device.

10. The method of claim 8, further comprising:
enabling user interaction to allow a user to transmit authorization data for one or more information resources;
performing user authorization on each of the information resources via the communication network using the authorization data, and
receiving authorization keys from the information resources via the communication network so as to transmit them to the server via the network connection, wherein
the addresses of information resources in the communication network, received from the server, additionally correspond to the authorization keys, and
each search query, transmitted by the user computing device via the communication network to an information resource in accordance with one of the information resource addresses, additionally contains an authorization key corresponding to the information resource.

11. The method of claim 10, wherein a headless web browser process is initiated to perform user authorization.

12. The method of claim 11, wherein each search query is transmitted to the corresponding information resource via the initiated headless web browser process, and search results from information resources to which the search queries were transmitted are received via the initiated headless web browser process.

13. The method of claim 8, further comprising:
initiating a headless web browser process to transmit each search query to the corresponding information resource via the communication network through the initiated headless web browser process;
receiving search results from information resources to which the search queries were transmitted via the initiated headless web browser process.

14. A computing device for performing data metasearch, comprising:
a user interaction module, configured to enable a user to enter a user search query, and
a computing module, in data communication with the user interaction module to receive the user search query from it and configured to perform at least the following operations, wherein:
enabling the creation of a network connection with a server for transmitting the received user search query via the network connection with the server;
enabling receipt from the server of one or more network addresses of information resources via the network connection in response to the entered user search query;
enabling the transmission of at least one search query via a communication network, associated with a user computing device identifier, to at least one of the information resources using a respective network address;
enabling receipt of search results from information resources to which the search queries were transmitted so as to enable their redirection to the server via the network connection, and
enabling receipt of ranked search results from the server via the network connection.

15. The computing device of claim 14, further comprising a display module in data communication with the computing module and configured to display to the user ranked search results.

16. The computing device of claim 14, wherein the user interaction module is further configured to enable a user to transmit authorization data for one or more information resources, and the computing module is further configured to perform at least the following operations, wherein:
transmitting the authorization data to the server via the network connection;
receiving from the server one or more server authorization requests, each of which corresponds to the user search query and corresponds to one of the information resources, for which authorization data were transmitted to the server, via the network connection so as to issue a user authorization request to each of the information resources corresponding to the server authorization requests via the communication network, and
receiving authorization keys from the information resources to which the user authorization requests were issued via the communication network so as to transmit them to the server via the network connection, wherein
the addresses of information resources in the communication network, received from the server, additionally correspond to the authorization keys, and
each search query, transmitted by the user computing device via the communication network to an information resource in accordance with one of the information resource addresses, additionally contains an authorization key corresponding to the information resource.

17. The computing device of claim 14, wherein the user interaction module is further configured to enable a user to transmit authorization data for one or more information resources, and the computing module is further configured to perform at least the following operations, wherein:
performing user authorization on each of the information resources via the communication network using the authorization data, and
receiving authorization keys from the information resources via the communication network so as to transmit them to the server via the network connection, wherein
the addresses of information resources in the communication network, received from the server, additionally correspond to the authorization keys, and
each search query, transmitted by the user computing device via the communication network to an information resource in accordance with one of the information resource addresses, additionally contains an authorization key corresponding to the information resource.

18. The computing device of claim 17, wherein the computing module is further configured to initiate a headless web browser process to perform user authorization.

19. The computing device of claim 18, wherein the computing module is further configured to transmit each search query to an information resource via the initiated headless web browser process and to receive search results from information resources to which the search queries were transmitted via the initiated headless web browser process.

20. The computing device of claim 14, wherein the computing module is further configured to initiate a headless web browser process to transmit each search query to the corresponding information resource via the communication network through the initiated headless web browser process and to receive search results from information resources to which the search queries were transmitted via the initiated headless web browser process.

21. A computing device for performing data metasearch, comprising:
a user interaction module, configured to enable a user to enter a user search query, and
a computing module, in data communication with the user interaction module to receive the user search query from it and configured to perform at least the following operations, wherein:
enabling the creation of a network connection with a server for transmitting the entered user search query via the network connection with the server;
enabling receipt from the server of one or more network addresses of information resources via the network connection in response to the entered user search query;
enabling the transmission of at least one search query via a communication network, associated with a user computing device identifier, to at least one of the information resources using a respective network address;
enabling receipt of search results from information resources to which the search queries were transmitted, and
ranking the received search results to obtain ranked search results, wherein
the user interaction module is further configured to enable a user to transmit authorization data for one or more information resources, and the computing module is further configured to perform at least the following operations, wherein:
transmitting the authorization data to the server via the network connection;
receiving from the server one or more server authorization requests, each of which corresponds to the user search query and corresponds to one of the information resources, for which authorization data were transmitted to the server, via the network connection so as to issue a user authorization request to each of the information resources corresponding to the server authorization requests via the communication network, and
receiving authorization keys from the information resources to which the user authorization requests were issued via the communication network so as to transmit them to the server via the network connection, wherein
the addresses of information resources in the communication network, received from the server, additionally correspond to the authorization keys, and
each search query, transmitted by the user computing device via the communication network to an information resource in accordance with one of the information resource addresses, additionally contains an authorization key corresponding to the information resource.

22. The computing device of claim 21, further comprising a display module in data communication with the computing module and configured to display to the user ranked search results.

23. The computing device of claim 21, wherein the user interaction module is further configured to enable a user to transmit authorization data for one or more information resources, and the computing module is further configured to perform at least the following operations, wherein:
performing user authorization on each of the information resources via the communication network using the authorization data, and
receiving authorization keys from the information resources via the communication network so as to transmit them to the server via the network connection, wherein
the addresses of information resources in the communication network, received from the server, additionally correspond to the authorization keys, and
each search query, transmitted by the user computing device via the communication network to an information resource in accordance with one of the information resource addresses, additionally contains an authorization key corresponding to the information resource.

24. The computing device of claim 23, wherein the computing module is further configured to initiate a headless web browser process to perform user authorization.

25. The computing device of claim 24, wherein the computing module is further configured to transmit each search query to an information resource via the initiated headless web browser process and to receive search results from information resources to which the search queries were transmitted via the initiated headless web browser process.

26. The computing device of claim 21, wherein the computing module is further configured to initiate a headless web browser process to transmit each search query to the corresponding information resource via the communication network through the initiated headless web browser process and to receive search results from information resources to which the search queries were transmitted via the initiated headless web browser process.

27. A method for performing data metasearch, the method comprising:
enabling, via a user computing device, a user to enter a user search query;
establishing, via a user computing device, a network connection with a server for transmitting the user search query via the network connection with the server;
transmitting, via the server, one or more network addresses of information resources via the network connection from the server to the user computing device in response to the entered user search query;
transmitting, via a user computing device, at least one search query via a communication network, associated with a user computing device identifier, to at least one of the information resources using a respective network address received from the server;
receiving, via a user computing device, search results from information resources to which the search queries were transmitted so as to redirect them to the server via the network connection;
ranking, via the server, the search results to obtain ranked search results so as to transmit them to the user computing device via the network connection.

28. The method of claim 27, further comprising:
displaying the ranked search results on a display module of the user computing device.

29. The method of claim 27, further comprising:
enabling, via a user computing device, a user to transmit authorization data for one or more information resources;
transmitting, via a user computing device, the authorization data to the server via the network connection;
processing, via the server, the authorization data to create one or more server authorization requests, each of which corresponds to the user search query and corresponds to one of the information resources, for which authorization data were transmitted to the server, so as to transmit the server authorization requests to the user computing device via the network connection;
transmitting, via a user computing device, a user authorization request to each of the information resources corresponding to the server authorization requests via the communication network, and
receiving authorization keys from the information resources to which the user authorization requests were issued via the communication network so as to transmit them to the server via the network connection, wherein
the addresses of information resources in the communication network, received from the server, additionally correspond to the authorization keys,
and each search query, transmitted by the user computing device via the communication network to an information resource in accordance with one of the information resource addresses, additionally contains an authorization key corresponding to the information resource.

30. The method of claim 27, further comprising:
enabling, via a user computing device, a user to transmit authorization data for one or more information resources;
performing, via a user computing device, user authorization on each of the information resources via the communication network using the authorization data, and
receiving, via a user computing device, authorization keys from the information resources via the communication network so as to transmit them to the server via the network connection, wherein
the addresses of information resources in the communication network, received from the server, additionally correspond to the authorization keys, and
each search query, transmitted by the user computing device via the communication network to an information resource in accordance with one of the information resource addresses, additionally contains an authorization key corresponding to the information resource.

31. The method of claim 30, wherein a headless web browser process is initiated, via a user computing device, to perform user authorization.

32. The method of claim 31, wherein each search query is transmitted, via a user computing device, to an information resource via the initiated headless web browser process, and search results from information resources to which the search queries were transmitted are received, via a user computing device, via the initiated headless web browser process.

33. The method of claim 27, further comprising:
initiating, via a user computing device, a headless web browser process to transmit each search query to the corresponding information resource via the communication network through the initiated headless web browser process, and
receiving, via a user computing device, search results from information resources to which the search queries were transmitted via the initiated headless web browser process.

34. A method for performing data metasearch, the method comprising:
enabling, via a user computing device, a user to enter a user search query;
establishing, via a user computing device, a network connection with a server for transmitting the entered user search query via the network connection with the server;
transmitting, via the server, one or more network addresses of information resources via the network connection from the server to the user computing device in response to the entered user search query;
transmitting, via a user computing device, at least one search query via a communication network, associated with a user computing device identifier, to at least one of the information resources using a respective network address received from the server;
receiving, via a user computing device, search results from information resources to which the search queries were transmitted, and
ranking, via a user computing device, the search results to obtain ranked search results;
further comprising:
enabling, via a user computing device, a user to transmit authorization data for one or more information resources;
transmitting, via a user computing device, the authorization data to the server via the network connection;
processing, via the server, the authorization data to create one or more server authorization requests, each of which corresponds to the user search query and corresponds to one of the information resources, for which authorization data were transmitted to the server, so as to transmit the server authorization requests to the user computing device via the network connection;
transmitting, via a user computing device, a user authorization request to each of the information resources corresponding to the server authorization requests via the communication network, and
receiving authorization keys from the information resources to which the user authorization requests were issued via the communication network so as to transmit them to the server via the network connection, wherein
the addresses of information resources in the communication network, received from the server, additionally correspond to the authorization keys, and
each search query, transmitted by the user computing device via the communication network to an information resource in accordance with one of the information resource addresses, additionally contains an authorization key corresponding to the information resource.

35. The method of claim 34, further comprising: displaying the ranked search results on a display module of the user computing device.

36. The method of claim 34, further comprising:
enabling, via a user computing device, a user to transmit authorization data for one or more information resources;
performing, via a user computing device, user authorization on each of the information resources via the communication network using the authorization data, and
receiving, via a user computing device, authorization keys from the information resources via the communication network so as to transmit them to the server via the network connection, wherein
the addresses of information resources in the communication network, received from the server, additionally correspond to the authorization keys, and
each search query, transmitted by the user computing device via the communication network to an information resource in accordance with one of the information resource addresses, additionally contains an authorization key corresponding to the information resource.

37. The method of claim 36, wherein a headless web browser process is initiated, via a user computing device, to perform user authorization.

38. The method of claim 37, wherein each search query is transmitted, via a user computing device, to an information resource via the initiated headless web browser process, and search results from information resources to which the search queries were transmitted are received, via a user computing device, via the initiated headless web browser process.

39. The method of claim 34, further comprising:
initiating, via a user computing device, a headless web browser process to transmit each search query to the corresponding information resource via the communication network through the initiated headless web browser process, and
receiving, via a user computing device, search results from information resources to which the search queries were transmitted via the initiated headless web browser process.

40. A system for performing data metasearch, comprising:
a server for performing data metasearch and
a user computing device for performing data metasearch, in data communication with the server via a communication network and containing at least one processor, configured to perform at least the following operations, wherein:
enabling user interaction to allow a user to enter a user search query and
establishing a network connection with the server via the communication network so as to enable transmitting the user search query via the network connection with the server, wherein
the server is further configured to transmit one or more network addresses of information resources via the network connection to the user computing device in response to the entered user search query,
the user computing device is further configured to transmit at least one search query via a communication network, associated with a user computing device identifier, to at least one of the information resources using a respective network address received from the server, and to receive search results from information resources to which the search queries were transmitted so as to enable their redirection to the server via the network connection, and
the server is further configured to rank the search results received from the user computing device to obtain ranked search results so as to enable their transmission to the user computing device via the network connection.

41. The system of claim 40, wherein the user computing device is further configured to display the ranked search results received from the server.

42. The system of claim 40, wherein the user computing device is further configured to enable a user to transmit authorization data for one or more information resources and is configured to transmit the authorization data to the server via the network connection, and the server is further configured to process the authorization data to create one or more server authorization requests, each of which corresponds to the user search query and corresponds to one of the information resources, for which authorization data were transmitted to the server, so as to enable transmission of the server authorization requests to the user computing device via the network connection, wherein
the user computing device is also configured to perform the following operations, wherein:
transmitting a user authorization request to each of the information resources corresponding to the server authorization requests via the communication network, and
receiving authorization keys from the information resources to which the user authorization requests were issued via the communication network so as to transmit them to the server via the network connection, wherein
the addresses of information resources in the communication network, received from the server, additionally correspond to the authorization keys,
and each search query, transmitted by the user computing device via the communication network to an information resource in accordance with one of the information resource addresses, additionally contains an authorization key corresponding to the information resource.

43. The system of claim 40, wherein the user computing device is further configured to perform at least the following operations, wherein:
enabling a user to transmit authorization data for one or more information resources;
performing user authorization on each of the information resources via the communication network using the authorization data, and
receiving authorization keys from the information resources via the communication network so as to transmit them to the server via the network connection, wherein
the addresses of information resources in the communication network, received from the server, additionally correspond to the authorization keys, and
each search query, transmitted by the user computing device via the communication network to an information resource in accordance with one of the information resource addresses, additionally contains an authorization key corresponding to the information resource.

44. The system of claim 43, wherein the user computing device is further configured to initiate a headless web browser process to perform user authorization.

45. The system of claim 44, wherein the user computing device is further configured to transmit each search query to an information resource via the initiated headless web browser process and to receive search results from information resources to which the search queries were transmitted via the initiated headless web browser process.

46. The system of claim 40, wherein the user computing device is further configured to initiate a headless web browser process to transmit each search query to the corresponding information resource via the communication network through the initiated headless web browser process and to receive search results from information resources to which the search queries were transmitted via the initiated headless web browser process.

47. A system for performing data metasearch, comprising:
a server for performing data metasearch and
a user computing device for performing data metasearch, in data communication with the server via a communication network and containing at least one processor, configured to perform at least the following operations, wherein:
enabling user interaction to allow a user to enter a user search query and establishing a network connection with the server via the communication network so as to enable transmitting the entered user search query via the network connection with the server, wherein
the server is further configured to transmit one or more network addresses of information resources via the network connection to the user computing device in response to the entered user search query, and
the user computing device is further configured to perform at least the following operations, wherein:
transmitting at least one search query via a communication network, associated with a user computing device identifier, to at least one of the information resources using a respective network address received from the server;
receiving search results from information resources to which the search queries were transmitted, and
ranking the received search results to obtain ranked search results, wherein
the user computing device is further configured to enable a user to transmit authorization data for one or more information resources and is configured to transmit the authorization data to the server via the network connection, and the server is further configured to process the authorization data to create one or more server authorization requests, each of which corresponds to the user search query and corresponds to one of the information resources, for which authorization data were transmitted to the server, so as to enable transmission of the server authorization requests to the user computing device via the network connection, wherein
the user computing device is also configured to perform the following operations, wherein:
transmitting a user authorization request to each of the information resources corresponding to the server authorization requests via the communication network, and
receiving authorization keys from the information resources to which the user authorization requests were issued via the communication network so as to transmit them to the server via the network connection, wherein
the addresses of information resources in the communication network, received from the server, additionally correspond to the authorization keys, and
each search query, transmitted by the user computing device via the communication network to an information resource in accordance with one of the information resource addresses, additionally contains an authorization key corresponding to the information resource.

48. The system of claim 47, wherein the user computing device is further configured to display the ranked search results received from the server.

49. The system of claim 47, wherein the user computing device is further configured to perform at least the following operations, wherein:
enabling a user to transmit authorization data for one or more information resources;
performing user authorization on each of the information resources via the communication network using the authorization data, and
receiving authorization keys from the information resources via the communication network so as to transmit them to the server via the network connection, wherein
the addresses of information resources in the communication network, received from the server, additionally correspond to the authorization keys, and
each search query, transmitted by the user computing device via the communication network to an information resource in accordance with one of the information resource addresses, additionally contains an authorization key corresponding to the information resource.

50. The system of claim 49, wherein the user computing device is further configured to initiate a headless web browser process to perform user authorization.

51. The system of claim 50, wherein the user computing device is further configured to transmit each search query to an information resource via the initiated headless web browser process and to receive search results from information resources to which the search queries were transmitted via the initiated headless web browser process.

52. The system of claim 47, wherein the user computing device is further configured to initiate a headless web browser process to transmit each search query to the corresponding information resource via the communication network through the initiated headless web browser process and to receive search results from information resources to which the search queries were transmitted via the initiated headless web browser process.
